(19) United States
(12) Patent Application Publication
(10) Pub. No.: US 2025/0053074 A1
(43) Pub. Date: Feb. 13, 2025

(54) LIGHT SOURCE DEVICE AND PROJECTION APPARATUS

(71) Applicants: Kazuhiro FUJITA, TOKYO (JP); Naoki NAKAMURA, SAITAMA (JP); Noritada OHI, SAITAMA (JP); Hiroki TANAKA, KANAGAWA (JP); Yoshio KUBO, TOKYO (JP); Toshiharu HACHISUKA, KANAGAWA (JP); Kasumi NAKAMURA, KANAGAWA (JP); Mayu BANNO, KANAGAWA (JP)

(72) Inventors: Kazuhiro FUJITA, TOKYO (JP); Naoki NAKAMURA, SAITAMA (JP); Noritada OHI, SAITAMA (JP); Hiroki TANAKA, KANAGAWA (JP); Yoshio KUBO, TOKYO (JP); Toshiharu HACHISUKA, KANAGAWA (JP); Kasumi NAKAMURA, KANAGAWA (JP); Mayu BANNO, KANAGAWA (JP)

(21) Appl. No.: 18/779,652

(22) Filed: Jul. 22, 2024

(30) Foreign Application Priority Data
Aug. 9, 2023 (JP) 2023-130069
Dec. 11, 2023 (JP) 2023-208715

(51) Int. Cl. G03B 21/20

(52) U.S. Cl. CPC G03B 21/2053; G03B 21/2013

(57) ABSTRACT

A light source device includes a first light source section including one or more first light emitters to emit first light; a second light source section including one or more second light emitters to emit second light; a light-transmissive member having a central axis to transmit the first light and the second light; and circuitry to individually drive the one or more first light emitters and the one or more second light emitters to reduce illuminance of light emitted from the light-transmissive member to below a predetermined illuminance level. The first light source section emits the first light that enters the light-transmissive member at a positive angle relative to the central axis in a view in a direction orthogonal to the central axis, and the second light source section emits the second light that enters the light-transmissive member at a negative angle relative to the central axis in the view.

### CROSS-REFERENCE TO RELATED APPLICATIONS

This patent application is based on and claims priority pursuant to 35 U.S.C. § 119(a) to Japanese Patent Application No. 2023-130069, filed on Aug. 9, 2023 and Japanese Patent Application No. 2023-208715, filed on Dec. 11, 2023, in the Japan Patent Office, the entire disclosure of which is hereby incorporated by reference herein.

### BACKGROUND

### Technical Field

Embodiments of the present disclosure relate to a light source device and a projection apparatus.

### Related Art

A light source device with multiple light emitters that emit light, as well as a projection apparatus such as a projector incorporating such a light source device, are known.

In order to extend the lifespan of the light source device and reduce power consumption, a configuration is disclosed in which, upon receiving a signal indicating the number of light sources to be turned on, the device selects the light sources to be used and turns off the light sources that are not selected.

However, in such devices, when the illuminance of the light emitted from the light source device is reduced below a predetermined level, illuminance unevenness may occur in the light emitted from the light source device, depending on the positions and other factors of the selected light sources among the multiple light sources.

### SUMMARY

An embodiment of the present disclosure provides a light source device including a first light source section including one or more first light emitters to emit first light; a second light source section including one or more second light emitters to emit second light; a light-transmissive member having a central axis to transmit the first light and the second light therethrough to emit the first light and the second light from the light-transmissive member; and circuitry configured to individually drive the one or more first light emitters and the one or more second light emitters to reduce illuminance of light emitted from the light-transmissive member to be below a predetermined illuminance level. The first light source section emits the first light that enters the light-transmissive member at a positive angle relative to the central axis in a view in a direction orthogonal to the central axis. The second light source section emits the second light that enters the light-transmissive member at a negative angle relative to the central axis in the view in the direction orthogonal to the central axis.

An embodiment of the present disclosure provides a light source device including a first light source section including one or more first light emitters to emit first light; a second light source section including one or more second light emitters to emit second light; a light-transmissive member having a central axis to transmit the first light and the second light therethrough to emit the first light and the second light from the light-transmissive member; and circuitry to: cause the one or more first light emitters to individually reduce first amount of the first light and cause the one or more second light emitters to individually reduce second amount of the second light; or individually turn off the one or more first light emitters and the one or more second light emitters. The circuitry alternately switches, at a switching cycle, between: a first state where both the first light and the second light enter the light-transmissive member at a positive angle relative to the central axis of the light-transmissive member in a view in a direction orthogonal to the central axis of the light-transmissive member; and a second state where both the first light and the second light enter the light-transmissive member at a negative angle relative to the central axis of the light-transmissive member in the view in the direction orthogonal to the central axis of the light-transmissive member.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a configuration of a light source device according to a first embodiment of the present disclosure;

FIG. 2 is a block diagram illustrating a functional configuration of a controller included in the light source device of FIG. 1;

FIG. 3 is a block diagram illustrating a functional configuration of a controller included in the light source device of FIG. 1;

FIG. 4 is a table representing corresponding information used by the controller of the light source device in FIG. 1;

FIG. 5 is a flowchart of processing processed by a controller included in the light source device of FIG. 1;

FIG. 6 is a diagram illustrating a configuration of a light source device according to a second embodiment of the present disclosure;

FIG. 7 is a plan view a wavelength converter included in the light source device of FIG. 6;

FIG. 8 is a plan view a color wheel included in the light source device of FIG. 6;

FIG. 9 is a graph of the relation between output of excitation light and output of wavelength-converted light in the light source device of FIG. 6;

FIG. 10 is a timing chart of the output of the excitation light in the first mode of the light source device in FIG. 6;

FIG. 11 is a timing chart of the output of the wavelength-converted light Ln in the first mode of the light source device in FIG. 6;

FIG. 12 is a timing chart of the output of the excitation light in the second mode of the light source device in FIG. 6;

FIG. 13 is a timing chart of the output of the wavelength-converted light Ln in the second mode of the light source device in FIG. 6;

FIG. 14 is a diagram illustrating a configuration of a light source device according to a third embodiment of the present disclosure;

FIG. 15 is a diagram of a first example of an illuminance distribution of light emitted from the light source device of FIG. 14;

FIG. 16 is a diagram of a second example of the illuminance distribution of the light emitted from the light source device of FIG. 14;

FIG. 17 is a diagram of a third example of the illuminance distribution of the light emitted from the light source device of FIG. 14;

FIG. 18 is a diagram of a fourth example of the illuminance distribution of the light emitted from the light source device of FIG. 14;

FIG. 19 is a diagram of a fifth example of the illuminance distribution of the light emitted from the light source device of FIG. 14;

FIG. 20 is a diagram illustrating a configuration of a light source device according to a modification of the third embodiment;

FIG. 21 is a diagram illustrating a configuration of a projection apparatus according to a fourth embodiment of the present disclosure;

FIG. 22 is a block diagram of an another example of a controller included in a light source device according to an embodiment of the present disclosure;

FIG. 23 is a flowchart of an operation of a light source device when switching a group of light sources at each startup of the light source device;

FIG. 24 is a flowchart of an operation of the light source device, illustrating switching of a group of light sources at predetermined time intervals, every predetermined number of days, or at predetermined cumulative lighting intervals;

FIG. 25 is a flowchart of an operation of a light source device, illustrating switching of a group of light sources after a predetermined time has elapsed since startup;

FIG. 26 is a flowchart of an operation of a light source device, illustrating switching of a group of light sources after a predetermined time has elapsed since startup and when an input signal has been switched;

FIG. 27 is a flowchart illustrating an operation of changing a predetermined switching time performed by a light source device;

FIG. 28 is a diagram illustrating an example of an (X+1)^{-th} switching period;

FIG. 29 is a diagram illustrating a configuration of a projection apparatus according to an embodiment of the present disclosure;

FIG. 30 is a diagram illustrating a first example of an operation mode of a light source device according to an embodiment of the present disclosure;

FIG. 31 is a diagram illustrating a second example of the operation mode of a light source device according to an embodiment of the present disclosure;

FIG. 32 is a diagram illustrating a third example of the operation mode of a light source device according to an embodiment of the present disclosure;

FIG. 33 is a diagram illustrating a configuration where light enters a light-transmitting element according to a modification of an embodiment of the present disclosure; and

FIGS. 34A to 34D are diagrams each illustrating a direction for defining angles of light.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

According to one aspect of the present disclosure, illuminance unevenness can be reduced when the illuminance of light emitted from a light source device is set lower than a predetermined illuminance.

Referring to the drawings, a light source device and a projection apparatus are described in detail according to embodiments of the present disclosure. The embodiments described below illustrate a light source device and a projection apparatus for embodying the technical concept of this embodiment, but are not limited to these examples.

The dimensions, materials, and shapes of components, relative arrangements thereof, and the like described below are not intended to limit the scope of the present disclosure unless otherwise specified and are only examples for explanation. For example, the size of these elements and the relative positions of these elements may be exaggerated for illustration in the drawings. In the description given below with reference to the drawings, like reference signs denote like elements, and overlapping description may be simplified or omitted as appropriate.

In the drawings, orthogonal coordinates with an X-axis, a Y-axis, and a Z-axis may be used to represent directions. The X-axis, the Y-axis, and the Z-axis are orthogonal to each other. The direction in which the arrow points along the X-axis is designated as the +X-direction, and the opposite direction as the −X-direction. The direction in which the arrow points along the Y-axis is designated as the +Y-direction, and the opposite direction as the −Y-direction. The direction in which the arrow points along the Z-axis is designated as the +Z-direction, and the opposite direction as the −Z-direction.

However, these terms indicating specific directions or positions are used merely to clarify the relative directions and positions in the reference drawings. These terms do not limit the orientation of the light source device and the projection apparatus according to the embodiment of the present disclosure during use, and the light source device and the projection device may be oriented in any direction during use.

In the embodiments of the present disclosure described below, the phrase “along the X-axis, the Y-axis, and the Z-axis” includes having an inclination within ±10 degrees with respect to these axes. Further, the terms “orthogonal” and “perpendicular” may include an error within ±10 degrees from 90 degrees.

### First Embodiment

### Overall Configuration Example of Light Source Device 100

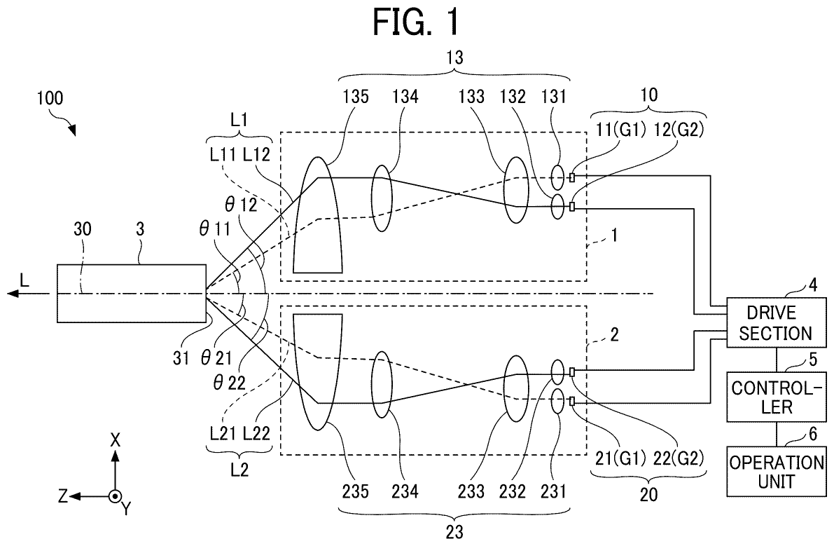

FIG. 1 is a diagram illustrating a configuration of a light source device 100 according to a first embodiment of the present disclosure.

As illustrated in FIG. 1, the light source device 100 includes a first light source section 1 that emits first light beams or light L1 from one or more first light emitters 10 and a second light source section 2 that emits second light beams or light L2 from one or more second light emitters 20. The light source device 100 further includes a light-transmitting element 3 (or a light-transmissive member) that transmits the first light L1 and the second light L2 that are incident thereon, and a drive section 4 that individually drives the one or more first light-emitters 10 and the one or more second light-emitters 20.

The light source device 100 emits the first light L1 and the second light L2, which are transmitted through the light-transmitting element 3. For example, the light-transmitting element 3 is a light homogenizer that combines the first light L1 and the second light L2 and homogenizes or uniformizes the illuminance of light emitted from the light source device 100. The light source device 100 emits light L having a uniform illuminance by being transmitted through the light-transmitting element 3. In FIG. 1, the light source device 100 emits the light L such that the principal ray of the light L travels in the +Z-direction. In the present specification, the principal ray refers to a light ray that travels on and along the central axis of a light beam, among light rays included in the light beam.

The drive section 4 individually reduces the amount of the first light L1 emitted from each of the one or more first light emitters 10 and the amount of the second light L2 emitted from each of the one or more second light emitters 20, or individually turns off the one or more first light emitters 10 and the one or more second light emitters 20. The first light L1 is incident on the light-transmitting element 3 at a positive angle with respect to the central axis 30 when the light-transmitting element 3 is viewed in the direction orthogonal to the central axis 30 of the light-transmitting element 3 (for example, from the upper side of the light source device 100 in the +Y-direction). The second light L2 is incident on the light-transmitting element 3 at a negative angle with respect to the central axis 30 when the light-transmitting element 3 is viewed in the direction orthogonal to the central axis 30 of the light-transmitting element 3.

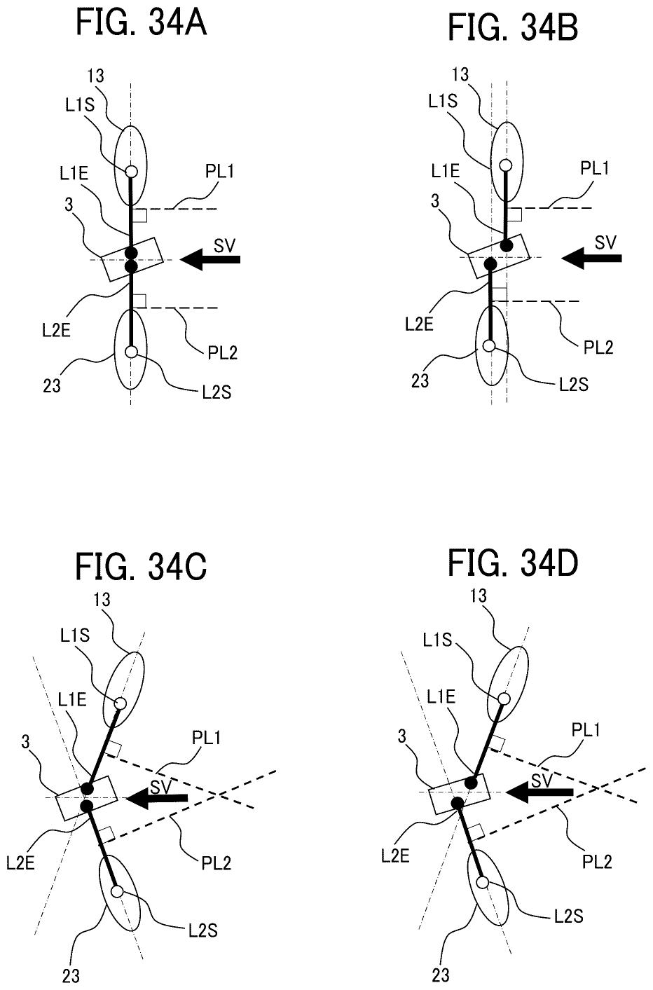

Preferably, the angles θ11, θ12, θ21, and θ22 are measured when viewed in a direction SV (or in a plane including the optical axis), which is described in FIGS. 34A to 34D. FIGS. 34A to 34D are cross-sectional views of the light-transmissive element 3, a first light-guiding optical system 13, and a second light-guiding optical system 23 when viewed in the Z-direction. The direction SV is in the Y-direction of FIG. 1. In FIGS. 34A to 34D, a first start point (L1S) that emits the first light toward the light-transmissive member is described on the first light source section 1, and a second start point (L2S) that emits the second light toward the light-transmissive member is described on the second light source section 2. Also, a first end point (L1E) that receives the first light from the first point and a second end point (L2E) that receives the second light from the first point are described on the light-transmissive member 3. As illustrated in FIGS. 34A to 34D, the direction SV is parallel to a line dividing an angle between a line PL1 and a line PL2 into symmetrical angles. The line PL1 is orthogonal to a line segment connecting the first start point L1S and the first end point L1E, and the line PL2 is orthogonal to a line segment connecting the second start point L2S and the second end point L2E. Further, when the line PL1 and the line PL2 are parallel, the direction SV is also parallel to the line PL1 and the line PL2.

In FIG. 1, the first light source section 1 includes two first light emitters 10 each including a first narrow-angle light emitter 11 and a first wide-angle light emitter 12. The first narrow-angle light emitter 11 and the first wide-angle light emitter 12 are arranged along the X-axis. The principal ray of first narrow-angle light L11 emitted from the first narrow-angle light emitter 11 passes through the light incidence surface 31 and enters the light-transmitting element 3 at a first narrow angle θ11 with respective to the central axis 30. The principal ray of first wide-angle light L12 emitted from the first wide-angle light emitter 12 passes through the light incidence surface 31 and enters the light-transmitting element 3 at a first wide angle θ12 with respective to the central axis 30. Both the first narrow angle θ11 and the first wide angle θ12 are positive angles.

The second light source section 2 includes two second light emitters 20 each including a second narrow-angle light emitter 21 and a second wide-angle light emitter 22. The second narrow-angle light emitter 21 and the second wide-angle light emitter 22 are arranged along the X-axis. The principal ray of second narrow-angle light L21 emitted from the second narrow-angle light emitter 21 passes through the light entrance surface 31 and enters the light-transmitting element 3 at a second narrow angle θ21. The principal ray of second wide-angle light L22 emitted from the second wide-angle light emitter 22 passes through the light entrance surface 31 and enters the light-transmitting element 3 at a second wide angle θ22. The second narrow angle θ21 and the second wide angle θ22 are both negative angles. In the light source device 100, the second light L2 including the second narrow-angle light L21 and the second wide-angle light L22 enters the light-transmitting element 3 at a negative angle (i.e., the second narrow angle θ21 or the second wide angle θ22).

In FIG. 1, the light rays from the first narrow-angle light emitter 11, the first wide-angle light emitter 12, the second narrow-angle light emitter 21, and the second wide-angle light emitter 22 are described using principal rays. However, in reality, each light emitter emits a light beam with a finite spread. Since light other than the principal ray, such as marginal rays, which are not illustrated in the present description, has a spread, these marginal rays may, in some cases, cross the central axis 30 of the light-transmitting element 3. In the present disclosure, reference is made to the principal rays or the light at the emission angle with the highest intensity, as the incident angle of the principal rays on the light-transmitting element 3 significantly affects the illuminance unevenness. No restrictions are placed on the peripheral light, which is typically weaker than the central light, emitted from each light emitter at angles other than the principal angle.

In the light source device 100, the drive section 4 individually reduces the amount of the first light L1 emitted from each of the one or more first light emitters 10 and the amount of the second light L2 emitted from each of the one or more second light emitters 20, or individually turns off the one or more first light emitters 10 and the one or more second light emitters 20. This allows for shorter emission times or reduced light output from each of the one or more first light emitters 10 and the one or more second light emitters 20, compared to constantly emitting the first light L1 and the second light L2 from the one or more first light emitters 10 and the one or more second light emitters 20 without reducing their light output. When constantly emitting the first light L1 and the second light L2 from one or more first light emitters 10 and one or more second light emitters 20 without reducing their light output, the average illuminance of light L emitted from the light source device 100 corresponds to a predetermined illuminance level.

In light source device 100, at least one of shortening emission times and reducing the light output can reduce the illuminance of light emitted from the light source device 100 to be below a predetermined illuminance level and extend the lifespan of one or more first light emitters 10 and one or more second light emitters 20. This can extend the lifespan of the light source device 100.

By individually reducing the amount of the first light L1 emitted from each of the one or more first light emitters 10 and the amount of the second light L2 emitted from each of the one or more second light emitters 20, or individually turning off the one or more first light emitters 10 and the one or more second light emitters 20, the anisotropy of the angle of the first light L1 and one or more second light L2 relative to the central axis 30 might become significant when they are incident on the light-transmitting element 3. The anisotropy of the angle relative to the central axis 30 may occur, for example, when both the first light L1 and one or more second light L2 are incident on the light-transmitting element 3 at positive angles relative to the central axis 30.

Such anisotropy may cause illuminance unevenness in the emitted light L. In the light source device 100, the first light L1 is incident on the light-transmitting element 3 at a positive angle relative to the central axis 30, whereas the second light L2 is incident at a negative angle relative to the central axis 30. This allows the light source device 100 to reduce the anisotropy of the incident angles of the first light L1 and the second light L2 relative to the central axis 30, reducing illuminance unevenness in the light L.

According to the present embodiment, illuminance unevenness can be reduced when the illuminance of light emitted from the light source device 100 is set lower than a predetermined illuminance. The angle of the first light L1 relative to the central axis 30 is, for example, the angle of the principal ray of the first light L1 relative to the central axis 30. The angle of the second light L2 relative to the central axis 30 is, for example, the angle of the principal ray of the second light L2 relative to the central axis 30. At least the principal ray of the first light L1 is incident on the light-transmitting element 3 at a positive angle relative to the central axis 30, and at least the principal ray of the second light L2 is incident on the light-transmitting element 3 at a negative angle relative to the central axis 30. This can effectively reduce illuminance unevenness in the light L if no light from the second light L2 is incident on the light-transmitting element 3 at a positive angle.

In FIG. 1, the first light L1 forms a positive angle with respect to the central axis 30, and the second light L2 forms a negative angle with respect to the central axis 30. However, the first light L1 may form a negative angle and the second light L2 may form a positive angle with respect to the central axis 30. The direction orthogonal to the central axis 30 of the light-transmitting element 3 is not limited to the +Y-direction as illustrated in FIG. 1, and may be any direction orthogonal to the central axis 30.

In FIG. 1, the light source device 100 includes a controller 5 that controls the operation of the drive section 4. The controller 5 includes a light-emission control unit described in FIG. 3. The light-emission control unit individually reduces the amount of the first light L1 emitted from each of the one or more first light emitters 10 and the amount of the second light L2 emitted from each of the one or more second light emitters 20, or individually turns off the one or more first light emitters 10 and the one or more second light emitters 20. The controller 5 controls the second light L2 to be incident on the light-transmitting element 3 at a negative angle relative to the central axis 30 when the light-transmitting element 3 is viewed in the direction orthogonal to the central axis 30. The controller 5 included in the light source device 100 can reduce illuminance unevenness when the illuminance of the light L emitted from the light source device 100 is reduced below the predetermined illuminance.

The light source device 100 can alternately turns on the first light source section 1 and the second light source section 2. Alternately turning on the first light source section 1 and the second light source section 2 can extend the lifespan of the light source device 100. Although only one of the first light source section 1 and the second light source section 2 is not turned on at any given moment, it is preferable to alternately turn on the first light source section 1 and the second light source section 2 within a time range that appears simultaneous to the human eye.

The interval (or switching cycle) at which the first light source section 1 and the second light source section 2 are alternately turned on is preferably a time corresponding to one frame at 24 to 50 frame per second (fps), as used in, for example, image generation.

In the light source device 100, even if the first light source section 1 and the second light source section 2 have unique illuminance unevenness, as long as this unevenness is sufficiently small, they can be switched over a long period, such as at each start up or daily, rather than instantly, without noticeable unevenness. It is commonly said that with an illuminance deviation of 50%, the illumination unevenness is noticeable to the human eye, whereas with an illumination deviation reduced to approximately 30%, the illumination unevenness is less noticeable. Further, if the illuminance unevenness of each of the first light source section 1 and the second light source section 2 is reduced to 10% or less, then operating them independently will not result in noticeable illumination unevenness. In other words, If the difference in illuminance unevenness between the first light source section 1 and the second light source section 2 is small, the switching cycle can be set without relying on the switching period.

The light source device 100 is not limited to alternately turning on the first light source section 1 and the second light source section 2, and can also turn on the first light source section 1 and the second light source section 2 at the same time. The light source device 100 can reduce the illuminance unevenness of the light emitted therefrom by simultaneously turning on the first light source section 1 and the second light source section 2.

In the light source device 100, when the light-transmitting element 3 is viewed in the direction orthogonal to the central axis 30, the absolute value of the angle of the principal ray of the first narrow-angle light L11 with respect to the central axis 30 is smaller than the absolute value of the angle of the principal ray of the first wide-angle light L12 with respect to the central axis 30. Further, when the light-transmitting element 3 is viewed in the direction orthogonal to the central axis 30, the absolute value of the angle of the principal ray of the second narrow-angle light L21 with respect to the central axis 30 is smaller than the absolute value of the angle of the principal ray of the second wide-angle light L22 with respect to the central axis 30. This can reduce the angle difference between the first light L1 and the second light L2, allowing the illuminance unevenness of the light L emitted from the light source device 100 to be reduced.

In the light source device 100, when the light-transmitting element 3 is viewed in the direction orthogonal to the central axis 30, the absolute value of the angle of the principal ray of the first narrow-angle light L11 with respect to the central axis 30 is equal to the absolute value of the angle of the principal ray of the second narrow-angle light L21 with respect to the central axis 30. Further, when the light-transmitting element 3 is viewed in the direction orthogonal to the central axis 30, the absolute value of the angle of the principal ray of the first wide-angle light L21 with respect to the central axis 30 is equal to the absolute value of the angle of the principal ray of the second wide-angle light L22 with respect to the central axis 30. This allows the light amounts of the first light L1 and the second light L2 to be nearly equal levels. Consequently, the illuminance unevenness of the light L emitted from the light source device 100 can be reduced.

In the light emitting device 100, the first narrow-angle light emitter 11 and the second narrow-angle light emitter 21 form a first group G1. The first wide-angle light emitter 12 and the second wide-angle light emitter 22 form a second group G2.

The drive section 4 alternately turns off the first group G1 and the second group G2, or alternately reduces the light amount of the first light L1 from the first group G1 and the light amount of the second light L2 from the second group G2. This allows for the reduction of the light amounts of the first light L1 and the second light L2 to nearly equal levels. Consequently, when the illuminance of the light L emitted from the light source device 100 is reduced below a predetermined level, illuminance unevenness can be minimized.

In the light source device 100, the drive section 4 alternately turns off the first group G1 and the second group G2, or alternately reduces the light amount of the first light L1 from the first group G1 and the light amount of the second light L2 from the second group G2, according to a predetermined switching cycle. This allows for the reduction of the light amounts of the first light L1 and the second light L2 to nearly equal levels over various predetermined cycles. For example, by shortening the switching cycle to a duration undetectable by the human eye, switching between the first group G1 and the second group G2 can be made inconspicuous.

Alternatively, by switching between the first group G1 and the second group G2 at each startup of the light source device 100, switching between the first group G1 and the second group G2 can be made inconspicuous.

This extends the lifespan of the light source device 100 while minimizing illuminance unevenness to make it less noticeable.

In the light source device 100, each of the first light emitter 10 and the second light emitter 20 includes at least one of a light-emitting diode element (LED) and a semiconductor laser element (LD). With this configuration, the light source device 100 performs high-speed control of turning on, turning off, or changing of light amount for both the first light emitter 10 and the second light emitter 20. Further, including a semiconductor laser element in each of the first light emitter 10 and the second light emitter 20 increases the light L output from the light source device 100.

In FIG. 1, the first light source section 1 includes a first light-guiding optical system 13 that guides the first light L1 emitted from one or more first light emitters 10 to the light-transmitting element 3. The first light-guiding optical system 13 includes a first lens 131, a second lens 132, a third lens 133, a fourth lens 134, and a fifth lens 135. The second light source section 2 includes a second light-guiding optical system 23 that guides the second light L2 emitted from one or more second light emitter 20 to the light-transmitting element 3. The second light-guiding optical system 23 includes a sixth lens 231, a seventh lens 232, an eighth lens 233, a ninth lens 234, and a tenth lens 235. The lenses included in the first light-guiding optical system 13 and the second light-guiding optical system 23 can be configured to include glass or resin having light-transmitting properties. The light-transmitting properties in this specification preferably has a transmittance of 60% or more for the first light L1 and the second light L2. The type, shape, arrangement, and number of the lenses included in the first light-guiding optical system 13 and the second light-guiding optical system 23 can be adjusted as needed. The first light-guiding optical system 13 and the second light-guiding optical system 23 may include various optical elements such as a mirror, a diffraction element, a micro electro mechanical systems (MEMS), and an optical fiber in addition to lenses. The number and arrangement of optical elements included in the first light-guiding optical system 13 and the second light-guiding optical system 23 can also be changed as appropriate.

The light-transmitting element 3 includes a light homogenizer such as a rod integrator. The light-transmitting element 3 is made of a resin or glass having light-transmitting properties. The light-transmitting element 3 is not limited to the light homogenizer as long as it can transmit the first light L1 and the second light L2. Even if the light-transmitting element 3 is not a light homogenizer, the light source device 100 of the present embodiment achieves reduced illumination unevenness when the illuminance of the light L emitted from the light source device 100 is reduced to below the predetermined illuminance level, compared to the case where the light source device 100 of the present embodiment is not applied. The light-transmitting element 3 may not be necessarily limited to a component in which light passes through a transmissive medium such as a resin or glass having light-transmitting properties. For example, the light-transmitting element 3 can be configured as a hollow light tunnel, which combines four flat mirrors to form a rectangular shape for the entrance and exit apertures. In this setup, the light is reflected and totally internally reflected multiple times by the mirror surfaces of the flat mirrors, achieving a light homogenizing effect.

The drive section 4 is configured by, for example, an electric circuit. The operation unit 6 receives an operation from the operator for the light source device 100. The operation unit 6 may include, for example, a touch panel, a button, and a keyboard. The operation unit 6 may be integrated with a display unit. The light source device 100 may include a housing that houses the first light source section 1, the second light source section 2, and the light-transmitting element 3. The drive section 4 and the controller 5 may be accommodated in the housing.

### Configuration Example of Controller 5

### Hardware Configuration

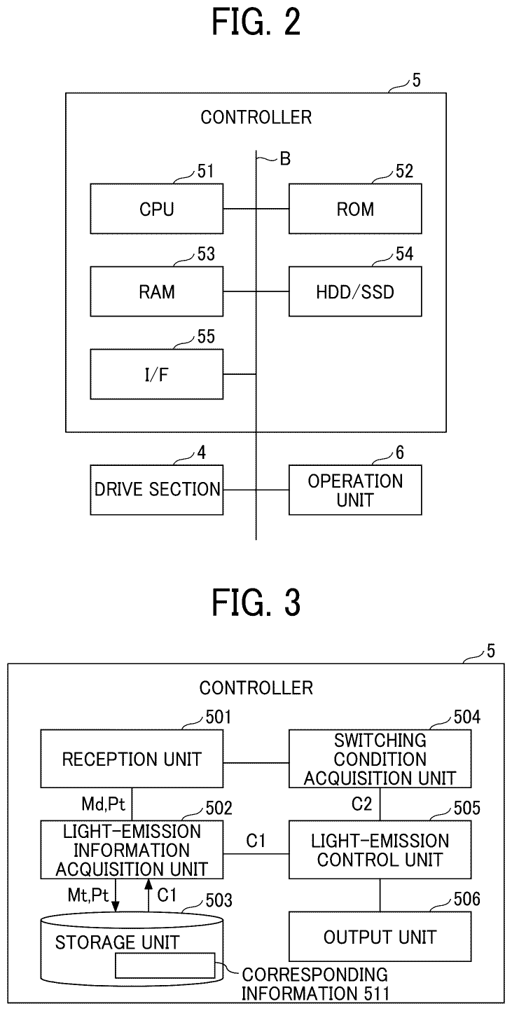

FIG. 2 is a block diagram illustrating a hardware configuration of the controller 5. The controller 5 includes a central processing unit (CPU) 51, a read only memory (ROM) 52, a random access memory (RAM) 53, a hard disk drive (HDD)/solid state drive (SSD) 54, and an interface (I/F) 55. These are connected to each other via a system bus B to be communicable with each other.

The CPU 51 executes control processing including various kinds of arithmetic processing. The ROM 52 is a nonvolatile memory that stores a program used for driving the CPU 51, such as an initial program loader (IPL). The RAM 53 is a volatile memory used as a work area of the CPU 51. The HDD/SSD 54 is a nonvolatile memory that stores various information and programs used for control by the controller 5.

The I/F 55 is an interface for performing communication between the controller 5 and a device or an apparatus other than the controller 5. The I/F 55 can also communicate with a device or an apparatus other than the controller 5 via, for example, a network. Devices other than the controller 5 include the drive section 4 and the operation unit 6. External devices other than the controller 5 include an external personal computer (PC) and an external server.

### Functional Configuration

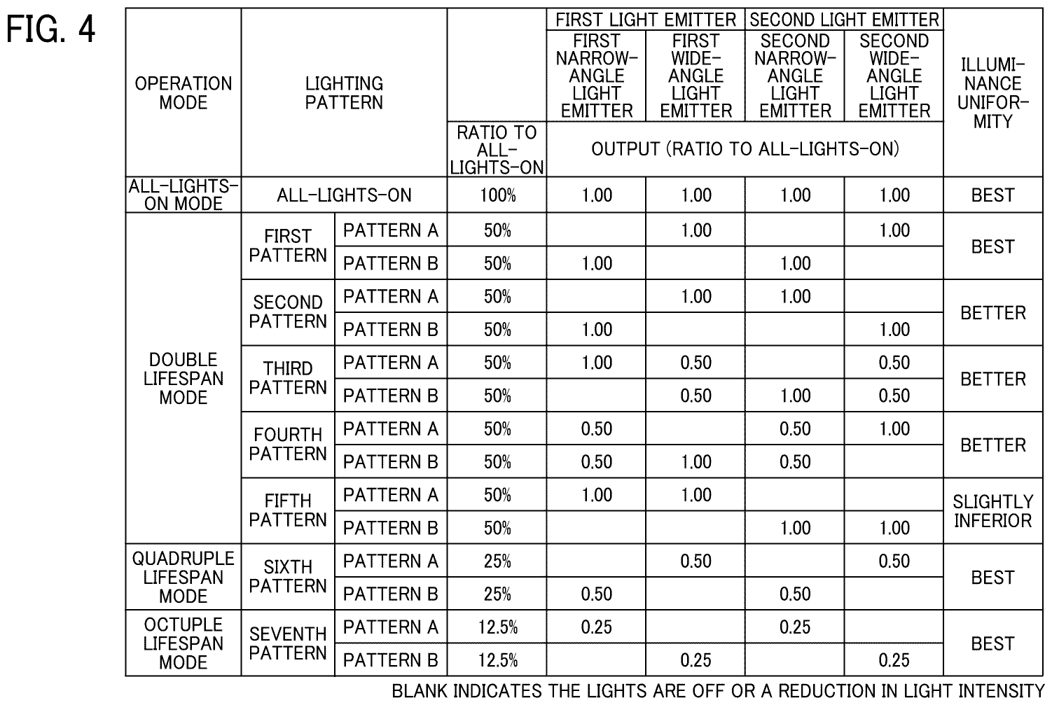

The functional configuration of the controller 5 is described with reference to FIGS. 3 and 4. FIG. 3 is a block diagram illustrating the functional configuration of the controller 5. FIG. 4 is a table representing an example of corresponding information 511 used by the controller 5.

As illustrated in FIG. 3, the controller 5 includes a reception unit 501, a light-emission information acquisition unit 502, a storage unit 503, a switching condition acquisition unit 504, a light-emission control unit 505, and an output unit 506.

The functions of the reception unit 501 and the output unit 506 are implemented by, for example, the I/F 55. A part of the functions of the reception unit 501 and the output unit 506 may be implemented by a processor such as the CPU 51 executing processing defined by program stored in the ROM 52. The function of the storage unit 503 is implemented by, for example, the RAM 53 and the HDD/SSD 54. The functions of the light-emission information acquisition unit 502, the switching condition acquisition unit 504, and the light-emission control unit 505 are implemented by a processor such as the CPU 51 executing processing defined by a program stored in the ROM 52.

Each function of the controller 5 is implemented by one or multiple processing circuits. The processing circuit includes a processor such as an application specific integrated circuit (ASIC), a digital signal processor (DSP), and a conventional circuit module designed to execute the above functions. Some of the functions of the controller 5 are implemented by an external device such as an external PC or an external server that is communicably connected to the controller 5. Further, some of the functions of the controller 5 are implemented by distributed processing between the controller 5 and these external devices.

The reception unit 501 controls communication with the operation unit 6 to receive the operation mode information Md, the lighting pattern information Pt of the light source device 100, the switching conditions of the first light emitter 10 and the second light emitter 20, which are selected and input by the operator via the operation unit.

The light-emission information acquisition unit 502 acquires the light-emission information C1 by referring to the corresponding information 511 stored in the storage unit 503, based on the operation mode information Md and the lighting pattern information Pt acquired by the reception unit 501.

The switching condition acquisition unit 504 acquires switching condition C2 via the reception unit 501 and provides it to the light-emission control unit 505.

The light-emission control unit 505 controls light-emission drive of one or more first light emitters 10 and one or more second light emitters 20 by the drive section 4. The light-emission control unit 505 controls the light-emission drive of one or more first light emitters 10 and one or more second light emitters 20 by the drive section 4 based on the light-emission information C1 and the switching condition C2.

The output unit 506 controls communication between the controller 5 and the drive section 4 in response to a command from the light-emission control unit 505.

As illustrated in FIG. 4, the corresponding information 511 is predefined information that establishes the relation between the operation mode information Md, the lighting pattern information Pt, and the light-emission information C1. The operation mode includes an all-lights-on mode, a double lifespan mode, a quadruple lifespan mode, and an octuple lifespan mode. The items for each operation mode include a lighting pattern, a ratio of light output to the all-lights-on, outputs of the first narrow-angle light emitter 11 and the first wide-angle light emitter 12 in the first light emitter 10, outputs of the second narrow-angle light emitter 21 and the second wide-angle light emitter 22 in the second light emitter 20, and illuminance uniformity of the light L.

The ratio of light output to the all-lights-on is represented as a percentage. The output is represented as a percentage. In FIG. 4, blanks in the columns indicating the outputs of the first narrow-angle light emitter 11, the first wide-angle light emitter 12, the second narrow-angle light emitter 21, and the second wide-angle light emitter 22 mean that the light emitter is turned off or its light output is reduced. The illuminance uniformity in FIG. 4 indicates the evaluation results of the uniformity for each operation mode and is not information used in the control of the first light emitter 10 and the second light emitter 20. Uniformity includes the categories, “BEST”, “BETTER”, and “SLIGHTLY INFERIOR” with “BEST” being the highest quality, followed by “BETTER”, and then “SLIGHTLY INFERIOR”.

The all-lights-on mode is an operation mode in which all of one or more first light emitters 10 and one or more second light emitters 20 are turned on. The lighting pattern in the all-lights-on mode is the all-lights-on pattern, with the ratio of light output to the all-lights-on being 100%. In FIG. 4, the outputs of the first narrow-angle light emitter 11, the first wide-angle light emitter 12, the second narrow-angle light emitter 21, and the second wide-angle light emitter 22 are all 1.00. The illuminance uniformity is “BEST”.

In the double lifespan mode, the light source device 100 operates with the amount of the first light L1 emitted from each of the one or more first light emitters 10 and the amount of the second light L2 emitted from the one or more second light emitters 20 individually reduced, or with the one or more first light emitters 10 and the one or more second light emitters 20 individually turned off. Thus, the lifespan of the light source device 100 becomes approximately double that of the all-lights-on mode. The lighting patterns of the double lifespan mode include first to fifth patterns, and each pattern includes a pattern A and a pattern B. In each pattern, the outputs of the first narrow-angle light emitter 11, the first wide-angle light emitter 12, the second narrow-angle light emitter 21, and the second wide-angle light emitter 22 are combined to achieve 50% of the ratio of light output to the all-lights-on. In the first pattern and the second pattern, the sum of the amount of light from the first narrow-angle light emitter 11 and the first wide-angle light emitter 12 is substantially equal to the sum of the amount of light from the second narrow-angle light emitter 21 and the second wide-angle light emitter 22. Thus, the illuminance uniformity is “BEST”. In the third pattern and the fourth pattern, the sum of the amount of light from the first narrow-angle light emitter 11 and the first wide-angle light emitter 12 is not equal to the sum of the amount of light from the second narrow-angle light emitter 21 and the second wide-angle light emitter 22. Thus, the illuminance uniformity is “BETTER”. In the fifth pattern, either the set of the first narrow-angle light emitter 11 and the first wide-angle light emitter 12 or the set of the second narrow-angle light emitter 21 and the second wide-angle light emitter 22 is turned on, whereas the other set is turned off. Thus, the illuminance uniformity is “SLIGHTLY POOR”.

In the quadruple lifespan mode, the light source device 100 operates with the amount of the first light L1 emitted from each of the one or more first light emitters 10 and the amount of the second light L2 emitted from each of the one or more second light emitters 20 individually reduced, or with the one or more first light emitters 10 and the one or more second light emitters 20 individually turned off. Thus, the lifespan of the light source device 100 becomes approximately quadruple that of the all-lights-on mode. The lighting pattern of the quadruple lifespan mode includes a sixth pattern. The sixth pattern includes the pattern A and the pattern B. In pattern A and pattern B of the sixth pattern, the outputs of the first narrow-angle light emitter 11, the first wide-angle light emitter 12, the second narrow-angle light emitter 21, and the second wide-angle light emitter 22 are combined to achieve 25% of the ratio of light output to the all-lights-on. In the sixth pattern, the sum of the amount of light from the first narrow-angle light emitter 11 and the first wide-angle light emitter 12 is substantially equal to the sum of the amount of light from the second narrow-angle light emitter 21 and the second wide-angle light emitter 22. Thus, the illuminance uniformity is “BEST”.

In the octuple lifespan mode, the light source device 100 operates with the amount of the first light L1 emitted from each of the one or more first light emitters 10 and the amount of the second light L2 emitted from each of the one or more second light emitters 20 individually reduced, or with the one or more first light emitters 10 and the one or more second light emitters 20 individually turned off. Thus, the lifespan of the light source device 100 becomes approximately octuple that of the all-lights-on mode. The lighting pattern of the octuple lifespan mode includes a seventh pattern. The seventh pattern includes the pattern A and the pattern B. In pattern A and pattern B of the seventh pattern, the outputs of the first narrow-angle light emitter 11, the first wide-angle light emitter 12, the second narrow-angle light emitter 21, and the second wide-angle light emitter 22 are combined to achieve 12.5% of the ratio of light output to the all-lights-on. In the seventh pattern, the sum of the amount of light from the first narrow-angle light emitter 11 and the first wide-angle light emitter 12 is substantially equal to the sum of the amount of light from the second narrow-angle light emitter 21 and the second wide-angle light emitter 22. Thus, the illuminance uniformity is “BEST”.

In the first pattern presented in FIG. 4, when viewed in the direction orthogonal to the central axis 30 in FIG. 1, the absolute value of the angle of the principal ray of the first light L1, emitted from the first narrow-angle light emitter 11 and incident on the light-transmitting element 3, relative to the central axis 30, is equal to the absolute value of the angle of the principal ray of the second light L2, emitted from the second narrow-angle light emitter 21 and incident on the light-transmitting element 3. Further, when viewed in the direction orthogonal to the central axis 30 in FIG. 1, the absolute value of the angle of the principal ray of the first light L1, emitted from the first wide-angle light emitter 12 and incident on the light-transmitting element 3, relative to the central axis 30, is equal to the absolute value of the angle of the principal ray of the second light L2, emitted from the second wide-angle light emitter 22 and incident on the light-transmitting element 3.

In the first to fourth patterns, the sixth pattern, and the seventh pattern of FIG. 4, the pattern A corresponding to the first group G1 and the pattern B corresponding to the second group G2 can be alternately performed. This configuration allows the first group G1 and the second group G2 to be alternately turned off, or the light amount of the first light L1 from the first group G1 and the light amount of the second light L2 from the second group G2 to be alternately reduced in FIG. 1.

In the fifth pattern of FIG. 4, when the light-transmitting element 3 is viewed in the direction orthogonal to the central axis 30 (or in a plane orthogonal to the central axis of the light-transmitting element 3), both the first light L1 and the second light L2 can be alternately switched at a predetermined cycle between a state where they are incident on the light-transmitting element 3 at a positive angle relative to the central axis 30 and a state where they are incident on the light-transmitting element 3 at a negative angle relative to the central axis 30. For example, by shortening the switching cycle to a duration undetectable by the human eye, the aforementioned switching can be made inconspicuous. This allows the illuminance of the light L emitted from the light source device 100 to be reduced below a predetermined level, extending the lifespan of the light source device 100 while minimizing illuminance unevenness to make it less noticeable.

The light source device 100 can alternate between the first group G1 and the second group G2 with each startup of the light source device 100. However, this is not limited to each startup; the switching between the groups can also be performed every predetermined number of startups of the light source device 100, at predetermined time intervals, every predetermined number of days, or at predetermined cumulative lighting intervals. These switching conditions are selected by the operator using, for example, the operation unit 6. The controller 5 acquires the selection result of the switching conditions through the reception unit 501 and set the switching conditions.

The predetermined switching cycle may be set by either storing the switching cycle information in a memory device as part of the controller 5 of the light source device 100, or by using a separate memory device. Alternatively, the switching cycle information may be read at each startup, and the light source device can operate based on that information. Additionally, information on the lighting time and lighting drive conditions, such as current and temperature, for each light-emitting section can be recorded, and the switching cycle can be determined based on cumulative lighting derived from this information. The information on the lighting time and lighting drive conditions, such as current and temperature, for each light-emitting section can be made accessible remotely, and the switching cycle information can be rewritten from an external source. The program used to calculate the switching information may also be updated. Further, if the driving information of the light source is read and an abnormality is detected based on predetermined criteria, the operation of the light source can be controlled to minimize illuminance unevenness and changes in chromaticity coordinates.om the driving information, the driving of the light source may be controlled to be turned on and off so as to minimize the illuminance unevenness and the change in chromaticity coordinates.

### Processing Example by Controller 5

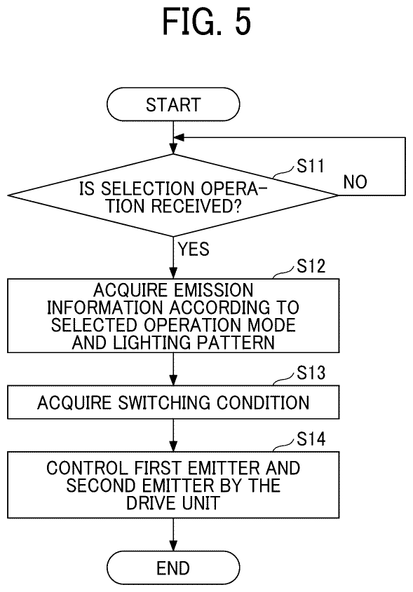

FIG. 5 is a flowchart of processing performed by a controller 5. In the processing of FIG. 5, a controller 5 of the light source device 100 changes the operation mode of the light source device 100 operating at a certain operation mode upon receiving a selection operation instructing a different operation mode.

In step S11, the controller 5 determines, via the reception unit 501, whether it has received operation mode information Md, lighting pattern information Pt, and switching condition C2 of the light source device 100, which are selected and input by the operator through the operation unit 6.

When the controller 5 determines that those information has not been received (No in step S11), the controller repeats the process of step S11. When the controller 5 determines that those information has been received (YES in step S11), the controller 5 performs a process in step S12.

In step S12, the controller 5 causes the light-emission information acquisition unit 502 to acquire the light-emission information C1 by referring to the corresponding information 511 stored in the storage unit 503, based on the operation mode information Md and the lighting pattern information Pt acquired via the reception unit 501. The light-emission information acquisition unit 502 provides the light-emission information C1 to the controller 5.

Subsequently, in step S13, the controller 5 causes the switching condition acquisition unit 504 to provide the switching condition C2 acquired via the reception unit 501 to the light-emission control unit 505.

In step S14, the controller 5 causes the light-emission control unit 505 to control the light-emission drive of one or more first light emitters 10 and one or more second light emitters 20 by the drive section 4, based on the light-emission information C1 and the switching condition C2.

As described above, the controller 5 performs the process of changing the operation mode when the light source device 100 is operating in a certain operation mode, upon receiving a selection operation that instructs a different operation mode.

### Second Embodiment

A light source device according to a second embodiment of the present disclosure is described below. In the following description, common or corresponding elements are denoted by the same or similar reference signs, and redundant description is appropriately simplified or omitted. The same applies to the embodiments of the present disclosure and the modifications thereof as will be described below.

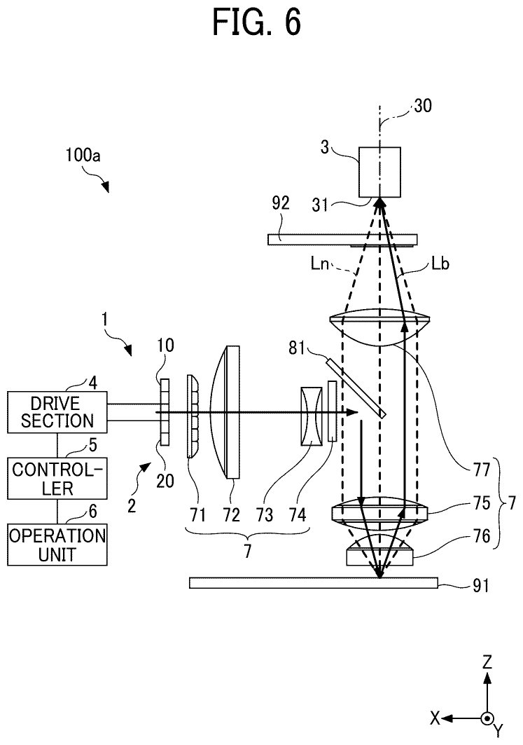

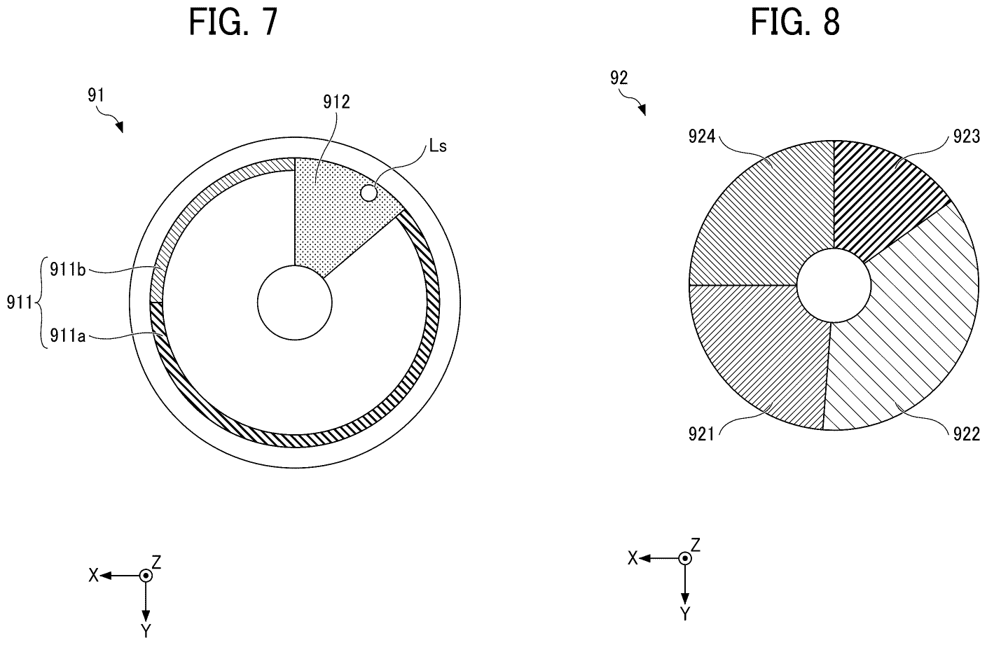

A configuration of the light source device according to the second embodiment is described with reference to FIGS. 6 to 8. FIG. 6 is a diagram illustrating a configuration of a light source device 100a according to the second embodiment. FIG. 7 is a plan view of a wavelength converter 91 included in the light source device 100a. FIG. 8 is a plan view of a color wheel 92 included in the light source device 100a.

The light source device 100a includes a rotatable wavelength converter 91 including a wavelength conversion area 911 and a reflective area 912. The light source device 100a includes a first light emitter 10 that emits first light L1 of blue color and a second light emitter 20 that emits second light L2 of blue color. The wavelength converter 91 emits wavelength-converted light Ln upon receiving the first light L1 and the second light L2 in the wavelength conversion area 911, and also emits reflected blue light Lb upon receiving the first light L1 and the second light L2 in the reflective area 912. Each of the wavelength-converted light Ln and the reflected blue light Lb emitted from the wavelength converter 91 is incident on a light-transmitting element 3 through, for example, the color wheel 92. In the light source device 100a, rotating the wavelength converter 91 allows the light-transmitting element 3 to alternately emit the wavelength-converted light Ln and the reflected blue light Lb. The features described above mostly differ from the first embodiment. The light source device 100a alternately emits the wavelength-converted light Ln and the reflected blue light Lb in the +Z-direction.

The light source device 100a, which alternately emits the wavelength-converted light Ln and the reflected blue light Lb, allows a reduction in illumination unevenness when the illuminance of light L emitted from the light source device 100a is lower than a prescribed level.

In FIG. 6, each of the first light emitter 10 and the second light emitter 20 is a unit with light-emitting sections arranged in a 2×7, 4×7, or similar two-dimensional array. The first light L1 from the first light emitter 10 and the second light L2 from the second light emitter 20 are in a blue wavelength range of more than 405 nm and less than 430 mm.

In FIG. 6, the light source device 100a includes a light-guiding optical system 7, a dichroic mirror 81, and a color wheel 92. The light-guiding optical system 7 guides the first light L1 of blue color from the first light emitter 10 and the second light L2 of blue color from the second light emitter 20 to the light-transmitting element 3. The light-guiding optical system 7 includes an eleventh lens 71, a twelfth lens 72, a thirteenth lens 73, a fourteenth lens 74, a fifteenth lens 75, a sixteenth lens 76, and a seventeenth lens 77. The eleventh lens 71 and the fourteenth lens 74 are each a lens array. The fifteenth lens 75 and the sixteenth lens 76 converge the first light L1 and the second light L2 onto the +Z-side surface of the wavelength converter 91. The seventeenth lens 77 condenses the wavelength-converted light Ln and the reflected blue light Lb onto a light incidence surface 31 of the light-transmitting element 3. An optical element included in the light-guiding optical system 7 includes material such as glass or resin that possesses light-transmitting properties. The type, shape, arrangement, and number of optical elements included in the light-guiding optical system 7 can be appropriately changed. The dichroic mirror 81 reflects the first light L1 of blue color and the second light L2 of blue color toward the wavelength converter 91 while transmitting the wavelength-converted light Ln and the reflected blue light Lb emitted from the wavelength converter 91. The color wheel 92 transmits the wavelength-converted light Ln and the reflected blue light Lb from the wavelength converter 91.

In FIG. 7, the wavelength converter 91 is a substantially circular plate when viewed in the +Z-direction. However, the wavelength converter 91 may be substantially rectangular, substantially elliptical, or a substantially polygonal when viewed in the +Z-direction. The wavelength converter 91 has a wavelength conversion area 911, which is a part of a circular ring, and a fan-shaped reflective area 912 on its +Z-side surface. The wavelength conversion area 911 includes a yellow fluorescent area 911a that emits yellow fluorescence and a green fluorescent area 911b that emits green fluorescence or yellowish green fluorescence. The reflective area 912 regularly reflects the first light L1 of blue color and the second light L2 of blue color, which are incident on the reflective area 912. The reflective area 912 diffusely reflects the first light L1 of blue color and the second light L2 of blue color, which are incident on the reflective area 912. A beam spot Ls in FIG. 7 represents a beam spot of the first light L1 or the second light L2 incident on the reflective area 912. The wavelength converter 91 is rotated about the center axis of the plate, allowing the positions of the respective areas to continuously change. The configuration of the wavelength converter 91 is not limited to that illustrated in FIG. 7, and can be changed as appropriate. For example, the wavelength conversion area 911 may be arranged in a fan shape, and the reflective area 912 may be arranged in a circular ring shape.

In FIG. 8, the color wheel 92 is a substantially circular plate when viewed in the +Z-direction.

However, the color wheel 92 may be substantially rectangular, substantially elliptical, or a substantially polygonal when viewed in the +Z-direction. The color wheel 92 has a fan-shaped red filter area 921, a fan-shaped yellow transmissive area 922, a fan-shaped blue diffusion area 923, and a fan-shaped green filter area 924 on its +Z-side surface.

The red filter area 921 transmits red light and absorbs other light. The yellow transmissive area 922 transmits red light.

The blue diffusion area 923 diffuses and transmits the incident reflected blue light Lb. The green filter area 924 transmits green light and absorbs other light.

The green filter area 924 may be a green transmission area that transmits green light.

The color wheel 92 is rotated about the center axis of the plate, allowing the positions of the respective areas to continuously change.

The configuration of the color wheel 92 is not limited to that illustrated in FIG. 8, and can be changed as appropriate. For example, the red filter area 921, the yellow transmissive area 922, the blue diffusion area 923, and the green filter area 924 may be arranged in a circular ring, or an additional area may also be added.

### Characteristics of Wavelength Conversion Area 911

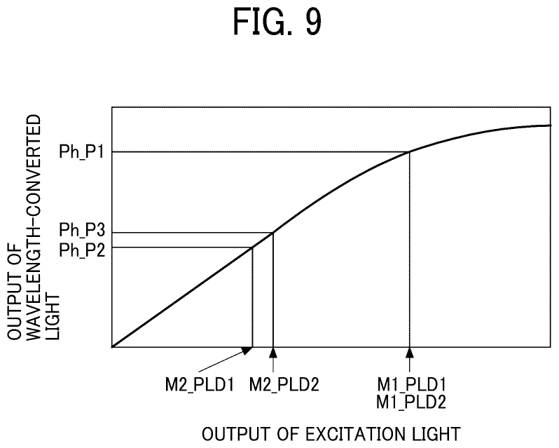

The characteristics of the wavelength conversion area 911 are described below. FIG. 9 is a graph of the relation between the output of excitation light and the output of wavelength-converted light Ln in the light source device 100a. In FIG. 9, the horizontal axis represents the output of excitation light. The excitation light corresponds to at least one of first light L1 emitted from the first light emitter 10 and incident on the wavelength conversion area 911 and second light L2 emitted from the second light emitter 20 and incident on the wavelength conversion area 911. Further, the vertical axis represents the output of the wavelength-converted light Ln.

In the light source device using the wavelength converter, for example, as the output of the excitation light increases, the wavelength converter that receives the excitation light heats up, leading to a decrease in conversion efficiency and a reduction in the output of the wavelength-converted light emitted from the wavelength converter. In other words, even if the output of the excitation light is halved, the output of the wavelength-converted light is not reduced to half; rather, it may exceed half of the output of the excitation light. As a result, the chromaticity coordinates and color temperature of the light emitted from the light source device change from the desired chromaticity coordinates and color temperature.

In the light source device 100a, the first light L1 and the second light L2, which are excitation light in a first wavelength range. The wavelength converter 91 emits light in a second wavelength range different from the first wavelength range upon receiving the first light L1 and the second light L2. The light source device 100a emits light in the first wavelength range that has not passed through the wavelength converter 91 during a period t1 and emits light in the second wavelength range emitted from the wavelength converter 91 during a period t2. In this case, the period t1 and the period t2 are independently set in consideration of color balance. The light source device 100a has two modes: a first mode to emit light at a first output level light by covering at least part of each of the light in the first wavelength range emitted during the period t1 and the light in the second wavelength range emitted during the period t2, or by combining at least part of the period t1 with at least part of the period t2; and a second mode to emit light at a second output level different from the first output level.

The ratio of M1_PLD1 to M1_PLD2 is defined as η1. In this case, M1_PLD1 indicates the output of the first light source section 1 to obtain light in the first wavelength range in the first mode, and M1_PLD2 indicates the output of the first light emitter 10 or the second light emitter 20 to obtain light in the second wavelength range in the first mode.

The ratio of M2_PLD1 to M2_PLD2 is defined as η2, which is different from η1. In this case, M2_PLD1 indicates the output of the first light emitter 10 or the second light emitter 20 to obtain light in the first wavelength range in the second mode, and M2_PLD2 indicates the output of the first light emitter 10 or the second light emitter 20 to obtain light in the second wavelength range in the second mode. Thus, in the light source device 100a, for example, when the output of the excitation light is reduced to half, the output of the wavelength-converted light Ln can also be halved.

In other words, in FIG. 9, when the output of the excitation light is changed from output M1_PLD1 or M1_PLD2 to output M2_PLD1, the output Ph_P2 of the wavelength-converted light Ln at output M2_PLD1 can be reduced to approximately half of the output Ph_P1 of the wavelength-converted light Ln at output M1_PLD1. As a result, even when the temperature of the wavelength converter 91 rises, it is possible to reduce changes in the chromaticity coordinates and color temperature of the light L emitted from the light source device 100a, achieving the desired chromaticity coordinates and color temperature.

In the light sources 100a, the ratio of the output of light in the second wavelength range emitted from the wavelength converter 91 upon receiving the light in the first wavelength range to the output of light in the first wavelength range incident on the wavelength converter 91 decreases as the output of the light in the first wavelength range increases. In the light source device 100a, even when the temperature of the wavelength converter 91 rises, it is possible to reduce changes in the chromaticity coordinates and color temperature of the light L emitted from the light source device 100a, achieving the desired chromaticity coordinates and color temperature.

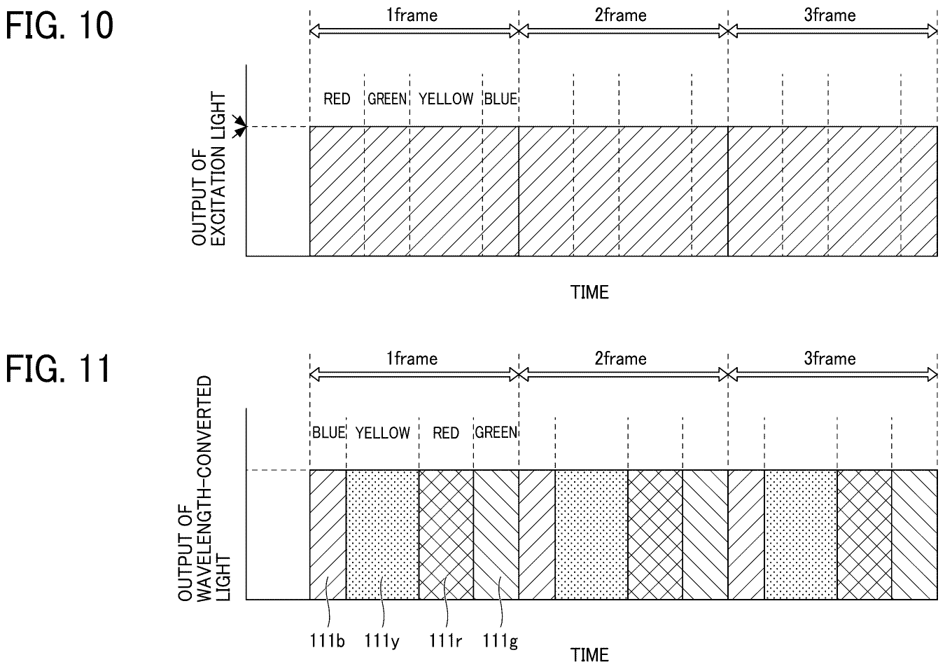

FIG. 10 is a timing chart of the output of the excitation light in the first mode of the light source device 100a. FIG. 11 is a timing chart of the output of the wavelength-converted light Ln in the first mode of the light source device 100a. In FIGS. 10 and 11, “frame” represents a predetermined frame cycle, “1 frame” represents a first frame period, “2 frame” represents a second frame period, and “3 frame” represents a third frame period. In FIG. 11, outputs 111b, 111y, 111r, and 111g represent outputs of blue light, yellow light, red light, and green light, respectively.

In FIGS. 10 and 11, the output M1_PLD1 of the excitation light source to obtain light including the first wavelength of range in the first mode, the output M1_PLD2 of the excitation light to obtain light including the second wavelength range, and their ratio η1 (i.e., M1_PLD1/M1_PLD2) are defined.

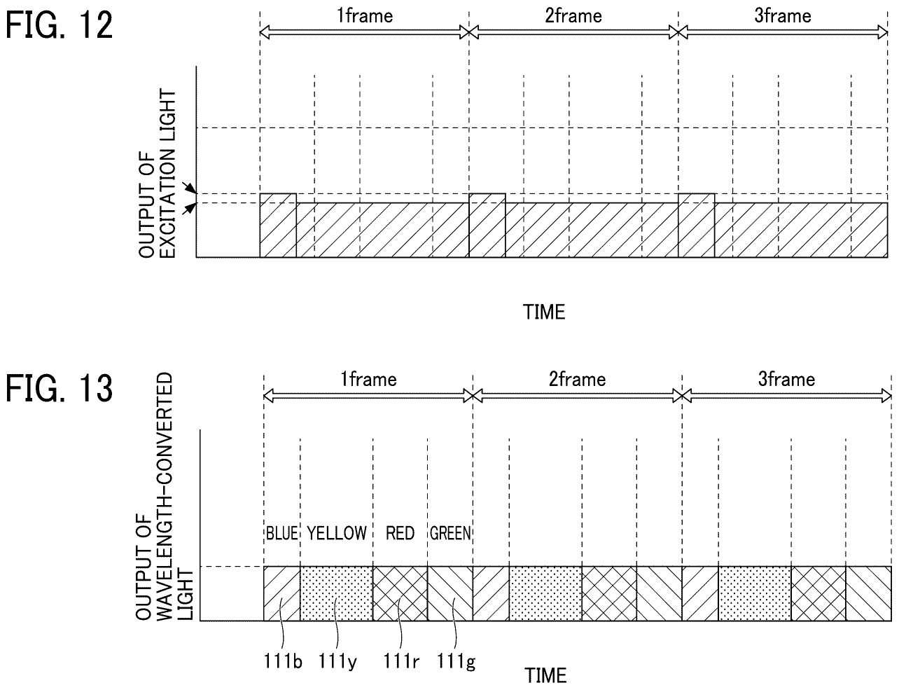

FIG. 12 is a timing chart of the output of the excitation light in the second mode of the light source device 100a. FIG. 13 is a timing chart of the output of the wavelength-converted light Ln in the second mode of the light source device 100a.

In FIGS. 12 and 13, the output M2_PLD1 of the excitation light to obtain light including the first wavelength of range in the second mode, the output M2_PLD2 of the excitation light to obtain light including the second wavelength range, and their ratio η2 (i.e., M2_PLD1/M2_PLD2) are defined.

In the light source device 100a, the amount of light emitted from the light source device 100a in the first mode is greater than that emitted in the second mode, and η1<η2 is satisfied. In the light source device 100a, even when the temperature of the wavelength converter 91 rises, it is possible to reduce changes in the chromaticity coordinates and color temperature of the light L emitted from the light source device 100a, achieving the desired chromaticity coordinates and color temperature.

The light source device 100a emits light with first chromaticity coordinates and color temperature in the first mode and emits light with second chromaticity coordinates and color temperature. The ratio η2 is set so that the first chromaticity coordinates and color temperature approximately match (or is substantially the same as) the second chromaticity coordinates and color temperature. In the light source device 100a, even when the conversion efficiency of the wavelength converter 91 changes due to, for example, a rise in temperature, it is possible to reduce changes in the chromaticity coordinates and color temperature of the light L emitted from the light source device 100a, achieving the desired chromaticity coordinates and color temperature.

The ratio η2 is set so that the first chromaticity coordinates and color temperature become similar to the second chromaticity coordinates and color temperature. The term “approximately match (or is substantially the same as)” means a range where the difference in chromaticity coordinates is indistinguishable to the human eye.

Typically, in terms of the coordinate distance in a uniform color space, it is desirable for ΔE*ab to be 3.0 or less when expressed in the CIE 1976 L*a*b* color space (CIELAB color space). For the purpose of producing a product, the value is more preferably 1.5 or less. For applications of more strict color evaluation, it is even more desirable for it to be 0.8 or less. The term “approximately or substantially” is defined as a standard of 3.0 or less, but is appropriately set according to the product specification.

In the light source device 100a, the wavelength converter 91 emits light in a third wavelength range upon receiving light in the second wavelength range. The light source device 100a emits at least the light in the first wavelength range and the light in the third wavelength range. In the light source device 100a, even when the temperature of the wavelength converter 91 rises, it is possible to reduce changes in the chromaticity coordinates and color temperature of the light L emitted from the light source device 100a, achieving the desired chromaticity coordinates and color temperature.

### Third Embodiment

A light source device according to a third embodiment of the present disclosure is described below.

### Configuration of Light Source Device 100b

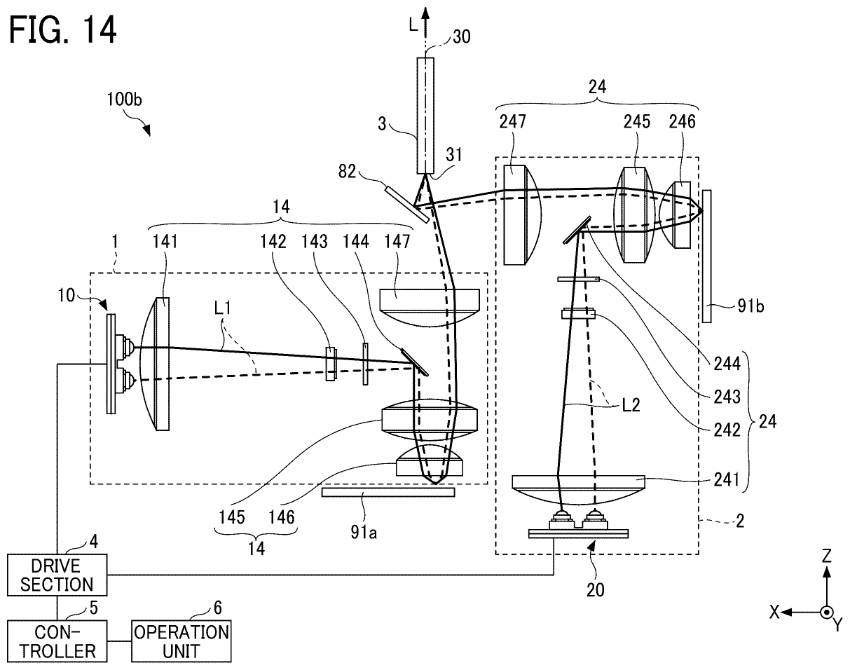

FIG. 14 is a diagram illustrating a configuration of a light source device 100b according to a third embodiment of the present disclosure.

The light source device 100b includes a rotatable first wavelength converter 91a and second wavelength converter 91b, each including a wavelength conversion area 911 and a reflective area 912. The first wavelength converter 91a and the second wavelength converter 91b may have substantially the same configuration. The first light emitter 10 emits first light L1 of blue color, and the second light emitter 20 emits second light L2 of blue color. A first wavelength converter 91a emits wavelength-converted light Ln upon receiving the first light L1 in the wavelength conversion area 911, and also emits reflected blue light Lb upon receiving the first light L1 in the reflective area 912. A second wavelength converter 91b emits wavelength-converted light Ln upon receiving the second light L2 in the wavelength conversion area 911, and also emits reflected blue light Lb upon receiving the second light L2 in the reflective area 912. In the light source device 100b, rotating the first wavelength converter 91a and the second wavelength converter 91b allows the light-transmitting element 3 to alternately emit the wavelength-converted light Ln and the reflected blue light Lb. The light source device 100b differs from the second embodiment in the following points.

In the light source device 100b, the light beams from the first light L1 and the second light L2, respectively, enter the light incidence surface 31 of the light-transmitting element 3 without overlapping each other on the surface. This allows the light beams from the first light L1 and the second light L2 to enter the light-transmitting element 3 without any loss.

This configuration enables higher efficiency in extracting the light L from the light-transmitting element 3. The light source device 100b enables a reduction in illuminance unevenness when the illuminance of the light L emitted from the light source device 100b is reduced to below the predetermined illuminance.

In FIG. 14, the direction in which the first light emitter 10 included in the first light source section 1 emits the first light L1 and the direction in which the second light emitter 20 included in the second light source section 2 emits the second light L2 intersect with each other. The first light emitter 10 emits the first light L1 in the −X-direction, and the second light emitter 20 emits the second light L2 in the +Z-direction. The first light emitter 10 emits the first light L1 with its principal ray proceeding in the −X-direction, and the second light emitter 20 emits the second light L2 with its principal ray proceeding in the +Z-direction. The −X-direction and the +Z-direction are substantially orthogonal to each other. This configuration allows the first light emitter 10 and the second light emitter 20 to be positioned closer together, reducing the space for the light source device 100b. As a result, the size of the light source device 100b can be reduced.

In FIG. 14, the light source device 100b includes a reflecting mirror 82. The first light source section 1 includes a third light-guiding optical system 14 that guides the first light L1 emitted from one or more first light emitter 10 to the light-transmitting element 3. The third light-guiding optical system 14 includes an eighteenth lens 141, a nineteenth lens 142, a twentieth lens 143, a first turning mirror 144, a twenty first lens 145, a twenty second lens 146, and a twenty third lens 147. The second light source section 2 includes a fourth light-guiding optical system 24 that guides the second light L2 emitted from one or more second light emitters 20 to the light-transmitting element 3. The fourth light-guiding optical system 24 includes a twenty fourth lens 241, a twenty fifth lens 242, a twenty sixth lens 243, a second turning mirror 244, a twenty seventh lens 245, a twenty eighth lens 246, and a twenty ninth lens 247. The lenses included in the third light-guiding optical system 14 and the fourth light-guiding optical system 24 can be configured to include glass or resin having light-transmitting properties. The type, shape, arrangement, and number of the lenses included in the third light-guiding optical system 14 and the fourth light-guiding optical system 24 can be adjusted as needed. The third light-guiding optical system 14 and the fourth light-guiding optical system 24 may include various optical elements such as a diffraction element, an MEMS, and an optical fiber in addition to lenses and mirrors. The number and arrangement of optical elements included in the third light-guiding optical system 14 and the fourth light-guiding optical system 24 can also be changed as appropriate.

In FIG. 14, the first light L1 emitted from the first light source section 1 passes through the vicinity of the reflecting mirror 82 and is directly incident on the light incidence surface 31 of the light-transmitting element 3. The second light L2 emitted from the second light source section 2 reflects off the reflecting mirror 82 and is incident on the light incidence surface 31 of the light-transmitting element 3. The light-transmitting element 3 can transmit the first light L1 and the second light L2 incident through the light incidence surface 31 and emit the light L.

In FIG. 14, the first light L1 emitted from the first light source section 1 is directly guided to the light incidence surface 31 of the light-transmitting element 3 without reflecting off the reflecting mirror 82, whereas the second light L2 emitted from the second light source section 2 reflects off the reflecting mirror 82 and is guided to the light incidence surface 31 of the light-transmitting element 3.

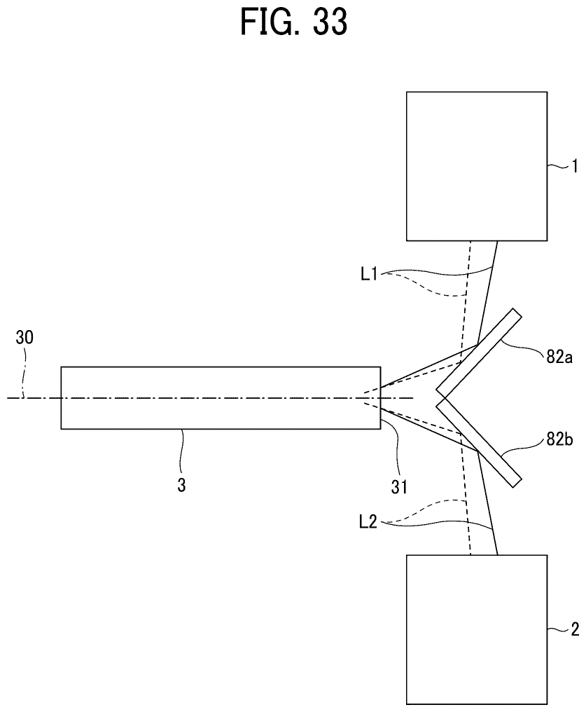

For example, as illustrated in FIG. 33, the first light L1 from the first light source section 1 and the second light L2 from the second light source section 2 may be reflected by reflecting mirrors 82a and 82b, respectively, and guided to the light incidence surface 31 of the light-transmitting element 3. The reflecting mirrors 82a and 82b may have a reflecting function, and may not be in the form of a flat plate. The inclined surface of the prism may have a reflecting function.

Further, the number of light source sections is not limited to two. The light source device may include three or more light source sections, such as a third light source section and a fourth light source section. At least two of these three or more light source sections are configured according to an embodiment of the present disclosure. In other words, an embodiment of the present disclosure can be applied to light emitted from two or more light source sections, each having different incidence angles to the light-transmitting element 3. The number of light source sections is not restricted.

Additionally, even if there is only one physical light source section, it is possible for this section to contain two or more light sources. When viewed from the direction orthogonal to the central axis of the light-transmitting element, some of the light beams emitted from the respective light sources may enter the light-transmitting element at positive angles relative to the central axis, while others may enter at negative angles. The present embodiment is applicable in such cases.

In other words, the first narrow-angle light emitter 11 and the first wide-angle light emitter 12 may be configured as a single light source section, and the second narrow-angle light emitter 21 and the second wide-angle light emitter 22 may be configured as a single light source section. The first light-guiding optical system and the second light-guiding optical system may be configured as the same light-guiding optical system.

### Illuminance Distribution Example

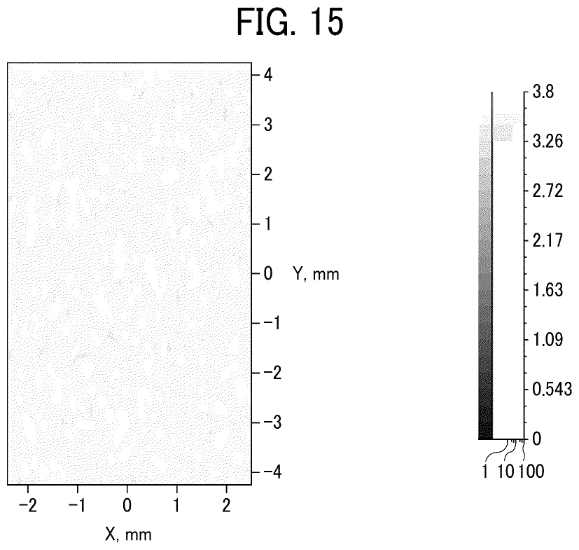

FIGS. 15 to 19 are diagrams each illustrating a illuminance distribution of light L emitted from the light source device 100. FIGS. 15 to 19 illustrate examples of the illuminance distributions of the light L under different conditions. Each example presents the results of a simulation calculating the illuminance distribution obtained in the vicinity of the emission surface of the light-transmitting element 3.

The first example as illustrated in FIG. 15 corresponds to the results of the all-lights-on mode in FIG. 4. The illuminance deviation in the first example was 6.98% across the entire area. The illuminance deviation is calculated by (maximum illuminance−minimum illuminance)/(maximum illuminance+minimum illuminance).

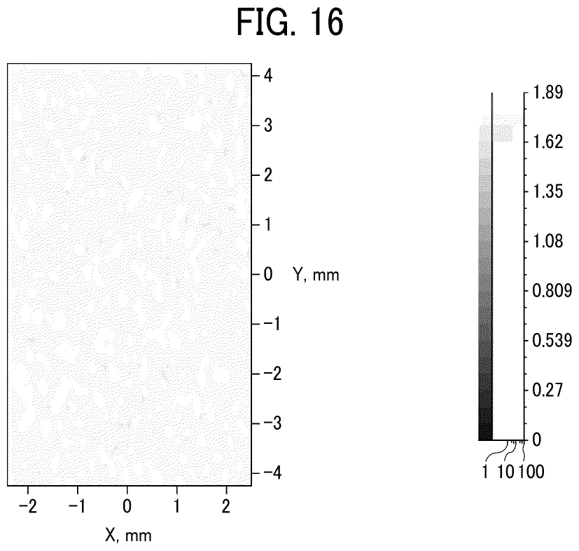

The second example illustrated in FIG. 16 presents a case where the first wide-angle light emitter 12 and the second wide-angle light emitter 22 are simultaneously turned on. This example corresponds to the results of pattern A of the first pattern, pattern A of the sixth pattern, and pattern B of the seventh pattern illustrated in FIG. 4. The illuminance deviation in the second example was 6.48% across the entire area.

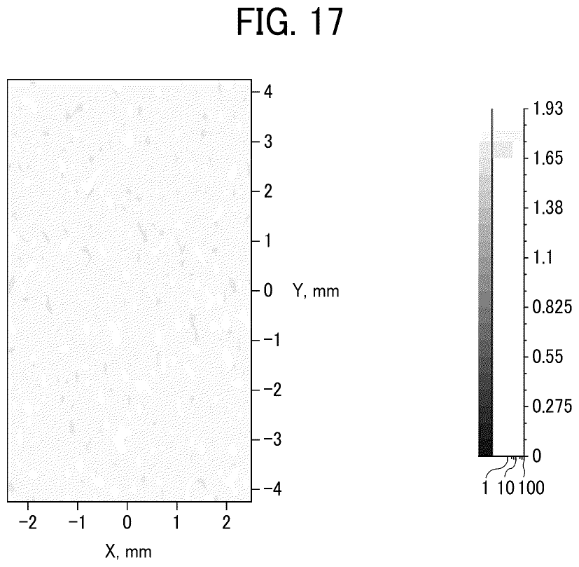

The third example illustrated in FIG. 17 presents a case where the first narrow-angle light emitter 11 and the second narrow-angle light emitter 21 are both turned on. This example corresponds to the results of pattern B of the first pattern, pattern B of the sixth pattern, and pattern A of the seventh pattern illustrated in FIG. 4. The illuminance deviation in the third example was 6.95% across the entire area.

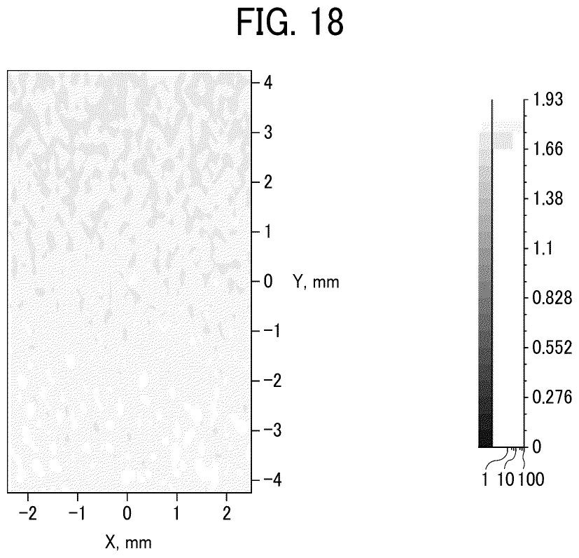

The fourth example illustrated in FIG. 18 presents a case where the first narrow-angle light emitter 11 and the first wide-angle light emitter 12 are both turned on. This example corresponds to the results of pattern A of the fifth pattern illustrated in FIG. 4. The illuminance deviation in the fourth example was 7.78% across the entire area.

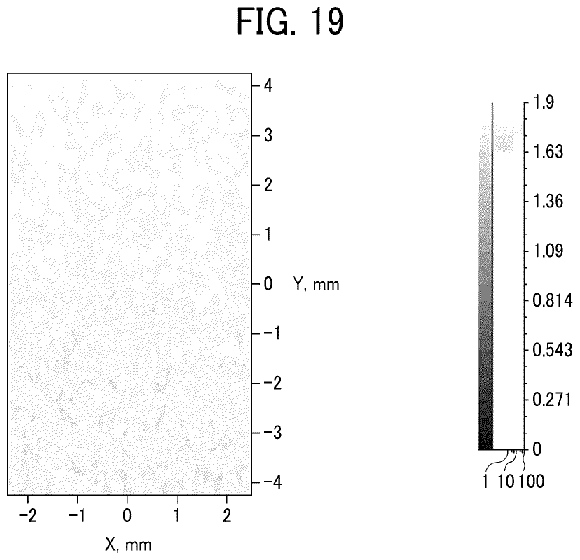

The fifth example illustrated in FIG. 19 presents a case where the first narrow-angle light emitter 11 and the first wide-angle light emitter 12 are both turned on. This example corresponds to the results of pattern B of the fifth pattern illustrated in FIG. 4. The illuminance deviation in the fifth example was 7.56% across the entire area.

From the above, it was found that in the first to fifth examples, the illuminance deviation can be reduced to 10% or less, and the illuminance unevenness can be reduced. It was found that illuminance unevenness can be reduced in the first to third examples compared to the fourth example and the fifth example.

The above illuminance deviation is defined across the entire illumination area, and it is set to a very ideal value of 10% or less, which is more than sufficient to achieve a light source device with reduced illuminance unevenness. When the light source device is incorporated into a projection apparatus, the illuminance deviation may not necessarily be 10% or less across the entire surface area.

For example, ensuring the desired illuminance deviation within a range that covers, for example, 90% of the area from the center toward the periphery of the image is sufficient for practical use. It depends on the specifications of an apparatus used.

The illuminance unevenness is typically identifiable when the illuminance deviation exceeds 50%, and it becomes less noticeable when the illuminance deviation falls to approximately 30%. The illuminance unevenness in the screen of the projection image of the projection apparatus appears as a result of integration of illuminance deviation of the light source device, light quantity deviation of the illumination optical system that illuminates the panel (i.e., the light quantity deviation of the illumination optical system), and the light quantity deviation of the projection lens. If a projection apparatus incorporating the light source device, an illumination system, and a projection system projects an image with an illuminance deviation of 30% or less, it can provide sufficient quality on its own. Simply increasing the illuminance deviation of the light source device alone cannot eliminate the illuminance unevenness of the entire system. It also depends on the light quantity deviations of the illumination optical system and the projection lens. As such, the illuminance deviation for the light source device should be determined in consideration of these specifications.

In situations where precise control of illuminance deviation is necessary, such as in stacked projections using multiple projection apparatuses or in tiled projections where multiple screens are combined, differing illuminance deviations between projection apparatuses can make the illuminance unevenness at the screen boundaries more noticeable. In these cases, an embodiment of the present disclosure is suitable.

In cases where a single projection apparatus is used without stacking or tiling, precise control of the illuminance deviation is not needed. Additionally, when the projection apparatus is used in a bright environment rather than a dark room, the brightness of the background makes the illuminance unevenness on the projection screen less noticeable. It is a well-known fact that the appearance of illuminance unevenness changes depending on the use environment. Thus, if the first light source section 1 and the second light source section 2 each satisfy the target illuminance deviation within a certain range from the center of the screen, it is sufficient to operate only the first light source section 1 for a certain period of time. It is sufficient to operate only the second light source unit 2 for a certain period of time. In other words, if the illuminance deviation values of the first light source section 1 and the second light source section 2 are small, each light source section can be operated independently in a predetermined switching cycle.

Additionally, it is preferable for the illuminance deviation value of each of the first light source section 1 and the second light source section 2 to be as small as possible. Thus, in the case of using the projection apparatus alone, the illuminance unevenness can be reduced by switching between the first light source section 1 and the second light source section 2 when the illuminance deviation values of both the first light source section 1 and the second light source section 2 are reduced to below the desired value. The desired value is preferably 10% or less across the entire area as in the fourth example of FIG. 18 and the fifth example of FIG. 19. It is desirable that the illuminance unevenness is 10% as the light source device. When combined with the unevenness of the illumination optical system and the projection optical system, the illuminance unevenness of the entire projection apparatus is preferably 30% or less.

If the illumination optical system and the projection optical system are ideally constructed with an individual deviation of 5% and a total deviation of 10%, the light source device can tolerate up to a deviation of 20%. Thus, smaller light quantity deviations in the illumination and projection optical systems allow for a larger acceptable illuminance deviation in the device.

In cases where multiple projection apparatuses are used, and a control system is employed to tile the projections from these apparatuses, having minimal illuminance unevenness in the adjacent projected images reduces the burden of image processing at the peripheral areas, enabling the construction of a brighter and more efficient projection system.

### Modification

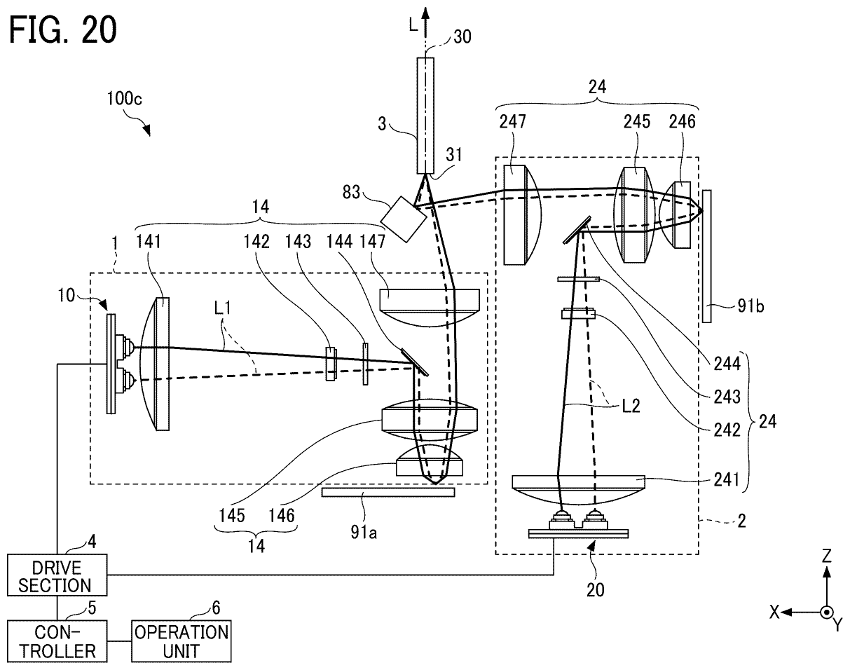

FIG. 20 is a diagram illustrating a configuration of a light source device 100c according to a modification of the third embodiment.

The light source device 100c differs from the third embodiment in that a prism 83 is used instead of the reflecting mirror 82. The light source device 100c including the prism 83 exhibits the same operational effects as those of the third embodiment.

### Fourth Embodiment

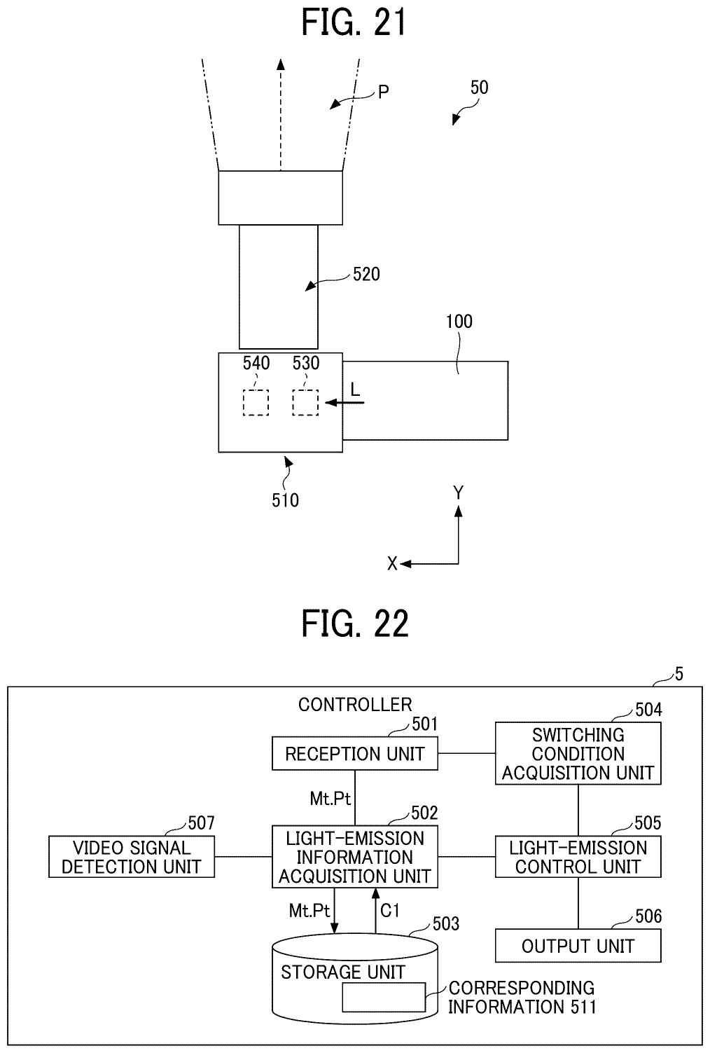

A projection apparatus according to a fourth embodiment of the present disclosure is described below. FIG. 21 is a diagram illustrating a configuration of a projection apparatus 50 according to a fourth embodiment of the present disclosure.

The projection apparatus 50 includes the light source device 100, the light modulator 540 that spatially modulates the light L emitted from the light source device 100, and the projection unit 520 that projects the light L modulated by the light modulator 540. This feature differs from the first embodiment.

The projection apparatus 50 illustrated in FIG. 21 includes an illumination optical system 510 and a projection unit 520 (or a projector), which are positioned downstream in the light-emission direction from the light source device 100 illustrated in FIG. 1. The light L from the light-transmitting element 3 of the light source device 100 enters the illumination optical system 510. The illumination optical system 510 emits the light L to the projection unit 520. The illumination optical system 510 includes various elements such as a color wheel 530 and a light modulator 540. The color wheel 530 is a disk that integrates red, blue, and green filters. As it rotates, it transmits the incident light L from the light source device 100 through these filters, converting the light into red, green, and blue light in a time-division manner. The light modulator 540, composed of a liquid crystal panel or a digital micro-mirror device (DMD), spatially modulates the light L from the color wheel 530.

The projection unit 520 projects light L modulated by the light modulator 540 in the illumination optical system 510 as a projection image P. In FIG. 21, the direction (Y-direction) in which the projection unit 520 projects the projection image P is orthogonal to the optical-axis direction (X-direction) of the light L emitted from the illumination device 100. In other words, the light source device 100 is arranged so that the optical-axis direction of the light L emitted from the light source device 100 is orthogonal to the arrangement direction (Y-direction) of the illumination optical system 510 and the projection unit 520. In this configuration, the light L emitted from the light source device 100 directly enters the illumination optical system 510.

The projection apparatus 50 incorporating the light source device 100 can reduce illuminance unevenness when the illuminance of the light L emitted from the light source device 100 is reduced below the predetermined illuminance. By setting the illuminance lower than the predetermined illuminance, the lifespan of the light source device 100 is extended. This reduces the frequency of replacing the light source device 100 and lowers the maintenance requirements for the projection apparatus 50. Further, reducing the illuminance unevenness of the light L emitted from the light source device 100 decreases the bright unevenness of the projection image P, resulting in a higher quality of the projection image P.

In the light source device 100 incorporated in the projection apparatus 50, the drive section 4 alternately turns off the first group G1 and the second group G2 (see FIG. 1), or alternately reduces the amount of the first light L1 from the first group G1 and the amount of the second light L2 from the second group G2, according to a predetermined switching cycle. In this case, the light modulator 540 can generate a projection image at a predetermined frame cycle, and the length of the switching cycle can be set to be equal to or less than the length of the frame cycle. This allows the switching between the first group G1 and the second group G2 to be unnoticeable to an observer of a projection image by the projection apparatus 50. In the fifth pattern of FIG. 4, the length of the switching cycle may be equal to or shorter than the length of the frame cycle when switching the first narrow-angle light emitter 11 and the first wide-angle light emitter 12, and the second narrow-angle light emitter 21 and the second wide-angle light emitter 22 for turning on. This allows the switching between the first group G1 and the second group G2 to be unnoticeable to an observer of a projection image by the projection apparatus 50.

In the light source device 100 incorporated in the projection apparatus 50, the drive section 4 alternately turns off the first group G1 and the second group G2, or alternately reduces the light amount of the first light L1 from the first group G1 and the light amount of the second light L2 from the second group G2. In this case, the drive section 4 allows the first group G1 and the second group G2 to be alternately turned off, or the light amount of the first light L1 from the first group G1 and the light amount of the second light L2 from the second group G2 to be alternately reduced, at each startup of the projection apparatus 50. This reduces illuminance unevenness when the illuminance of light emitted from the light source device 100 is set lower than a predetermined illuminance to make it inconspicuous.

The interval (or switching cycle) for alternately turning off the first light source section 1 and the second light source section 2 or for alternately reducing the first light L1 and the second light L2 is preferably a time corresponding to one frame at 24 to 50 fps, as used in, for example, image generation. With sufficiently small illuminance deviation between the first light source section 1 and the second light source section 2 or between the first light L1 and the second light L2, the switching cycle does not need to be short but can be longer, such as at each startup of the device.

The projection apparatus 50 may include the light source device 100a, the light source device 100b, or the light source device 100c instead of the light source device 100. However, since the light source device 100a includes the color wheel 92, the illumination optical system 510 may not include the color wheel 530 therein in a case where the projection apparatus 50 includes the light source device 100a.

### MODIFICATION

Various other examples of the present disclosure are described below.

### First Example

FIG. 22 is a block diagram of another example of a controller 5 included in the light source device 100. In FIG. 22, the controller 5 according to the present example differs from the controller 5 of FIG. 3 in that the controller 5 of FIG. 22 includes a video signal detection unit 507.

When the light source device 100 continues to operate in a specific operation mode other than the all-lights-on mode, a specific light emitter may continue to deteriorate, possibly causing variations in use time between the light emitters. For example, if the light emitter includes a semiconductor laser element, it is known that even under the same operating conditions, such as current and temperatures, its output can decrease to about half over long-term use (e.g., 20,000 hours). Thus, it is desirable to average the use time for the first narrow-angle light emitter 11 and the first wide-angle light emitter 12 of the first light emitter 10, and the second narrow-angle light emitter 21 and the second wide-angle light emitter 22 of the second light emitter 20. By averaging the use time, it is possible to reduce the variations in the light source output due to the switching of the operation mode.

In this example, the video signal detection unit 507 detects the connection of a video signal cable such as high-definition multimedia interface (HDMI, registered trademark) to the I/F 55, or the reception of video signals from an external personal computer (PC) or external server via a network or other means. The video signal detection unit 507 can detect the connection of a video signal cable or the reception of a video signal, to determine parameters such as resolution, frame rate, and display format (e.g., color format or 3D).

The controller 5 controls the operations of the first narrow-angle light emitter 11, the first wide-angle light emitter 12, the second narrow-angle light emitter 21, and the second wide-angle light emitter 22. It ensures that their usage times are averaged according to the resolution, frame rate, and display format determined by the video signal detection unit 507. This reduces the variations in use time between the first narrow-angle light emitter 11, the first wide-angle light emitter 12, the second narrow-angle light emitter 21, and the second wide-angle light emitter 22, resulting in reduced variations in light source output due to the switching of the operation mode.

### Second Example

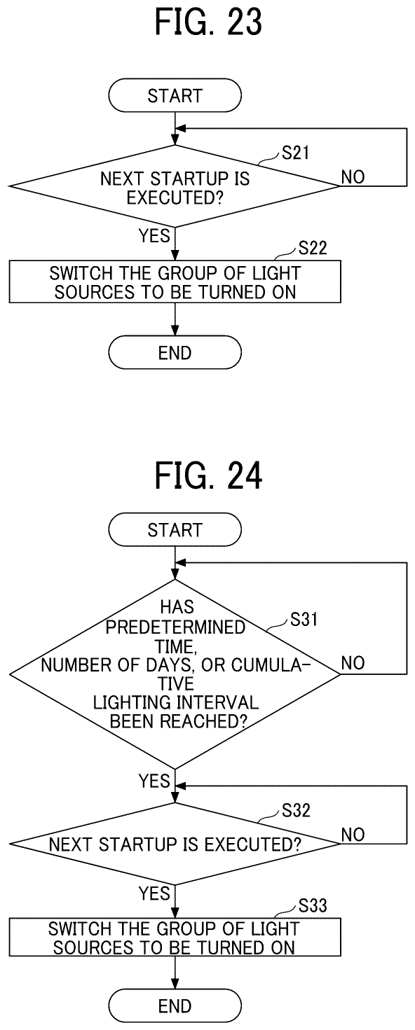

As described in the first embodiment, the light source device 100 switches between the first group G1 and the second group G2 at each startup of the light source device 100. FIG. 23 is a flowchart of an operation of the light source device 100 when switching the group at each startup of the light source device 100.

In FIG. 23, in step S21, the light source device 100 determines whether its next startup has been executed.

When the light source device 100 determines that its next startup has not been executed (NO in step S21), it repeats the process of step S21 until it determines that the startup has been executed. When the light source device 100 determines that its next startup has been executed (YES in step S21), it switches the group of light sources to be turned on in step S22. Then, the light source device 100 ends the operation.

As described above, the light source device 100 can switch the group at each startup of the light source device 100.

### Third Example

As described in the first embodiment of the present disclosure, the light source device 100 can switch between groups such as the first group G1 and the second group G2 at predetermined time intervals, every predetermined number of days, or at predetermined cumulative lighting intervals. FIG. 24 is a flowchart of an operation of the light source device 100, illustrating the switching of the group at predetermined time intervals, every predetermined number of days, or at predetermined cumulative lighting intervals.

In FIG. 24, in step S31, the light source device 100 determines whether any one of the predetermined time, predetermined number of days, and predetermined cumulative lighting interval has been reached.

When the light source device 100 determines that any one of the predetermined time, predetermined number of days, and predetermined cumulative lighting interval has not been reached (NO in step S31), it repeats the process of step S31 until it determines that any one of the predetermined time, predetermined number of days, and predetermined cumulative lighting interval has been reached.

When the light source device 100 determines that any one of the predetermined time, predetermined number of days, and predetermined cumulative lighting interval has been reached (YES in step S31), it further determines whether next startup has been executed. When the light source device 100 determines that its next startup has not been executed (NO in step S32), it repeats the process of step S32 until it determines that next startup has been executed. When the light source device 100 determines that its next startup has been executed (YES in step S32), it switches the group of light sources to be turned on in step S33. Then, the light source device 100 ends the operation.

As described above, the light source device 100 can switch between groups such as the first group G1 and the second group G2 at predetermined time intervals, every predetermined number of days, or at predetermined cumulative lighting intervals.

### Fourth Example

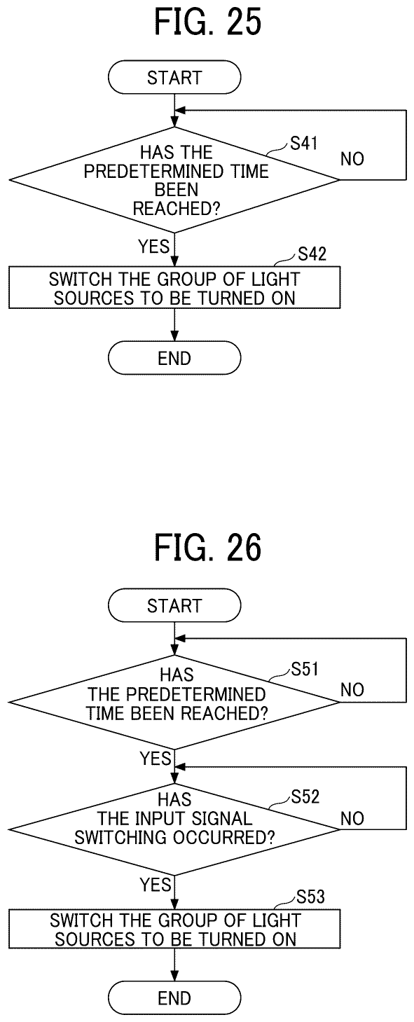

The light source device 100 can switch between the first group G1 and the second group G2, to be used, after a predetermined time has elapsed since the startup. FIG. 25 is a flowchart of an operation of the light source device 100, illustrating the switching of the group after a predetermined time has elapsed since the startup.

In FIG. 25, in step S41, the light source device 100 determines whether the elapsed time has reached a predetermined time since its startup.

When the light source device 100 determines that the elapsed time has not reached a predetermined time since its startup (NO in step S41), it repeats the process of step S41 until it determines that the elapsed time has reached a predetermined time since its startup.

When the light source device 100 determines that the predetermined time has been reached (YES in step S41), it switches the group of light sources to be turned on in step S42. Then, the light source device 100 ends the operation.

As described above, the light source device 100 can switch the group to be used, after the predetermined time has elapsed since the startup.

For example, under the conditions such as predetermined time intervals, every predetermined number of days, or predetermined cumulative lighting intervals, as described in the third example, the group of light sources to be used will be switched at the next startup after any one of the conditions is satisfied. However, when the light source device 100 is driven for a long time for signage, its next startup may not occur. This causes a difference between the set switching time and the actual switching time, leading to a disparity in operating time between multiple groups and possibly resulting in uneven illuminance. Even during startup, the group is immediately switched after the predetermined time has elapsed, so as to maintain equal driving time between the multiple groups.

### Fifth Example

The light source device 100 may switch the group to be used, such as the first group G1 and the second group G2, after a predetermined time has elapsed since startup and when the input signal has been switched. FIG. 26 is a flowchart of an operation of the light source device 100, illustrating the switching of the group after a predetermined time has elapsed since the startup and when the input signal is switched.

In FIG. 26, in step S51, the light source device 100 determines whether the elapsed time has reached a predetermined time since its startup.

When the light source device 100 determines that the elapsed time has not reached a predetermined time since its startup (NO in step S51), it repeats the process of step S51 until it determines that the elapsed time has reached a predetermined time since its startup.

When the light source device 100 determines that the elapsed time has reached a predetermined time since its startup (YES in step S51), it further determines whether an input signal switch has occurred. When the light source device 100 determines that an input signal switch has not occurred (NO in step S52), it repeats the process of step S52 until it determines that an input signal switch has occurred. When the light source device 100 determines that an input signal switch has occurred (YES in step S52), it switches the group of light sources to be turned on in step S53.

As described above, the light source device 100 can switch the group to be used, after the predetermined time has elapsed since the startup and when an input signal is switched.

For example, if the light source group is switched immediately during startup, a break occurs in the video during regular use (not for signage), which may trouble the user of the light source device 100. In the present example, the light source groups are switched at the time of any projection changes, such as switching an input signal, displaying test patterns, or projecting a logotype, or when a predetermined time has elapsed since startup. This enables the switching of the light source group with less intermittent video.

### Sixth Example

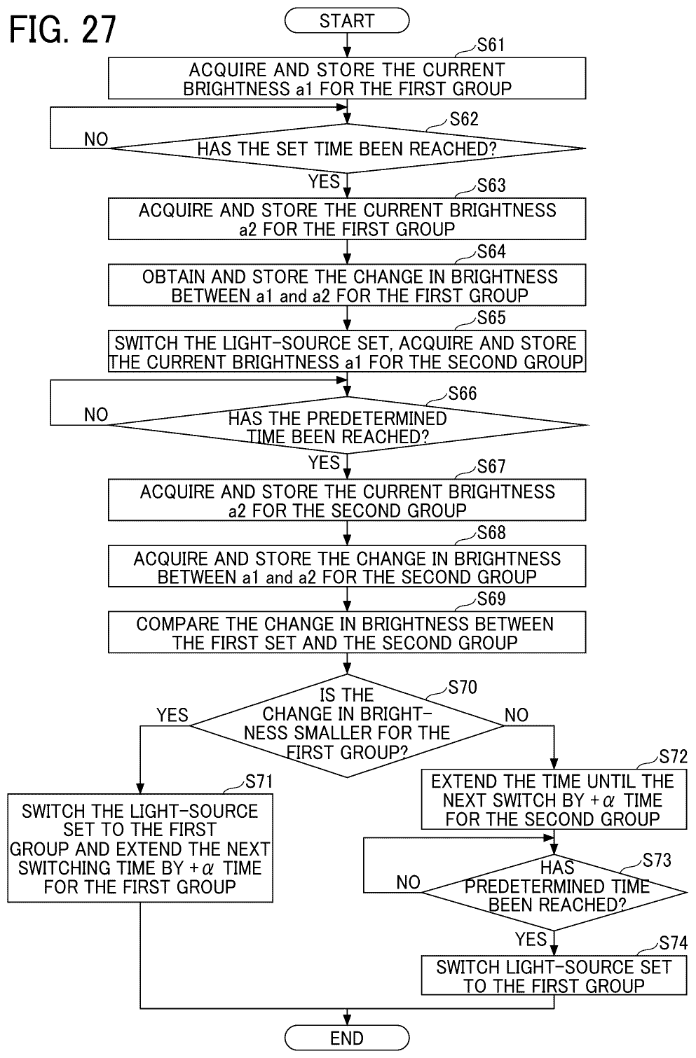

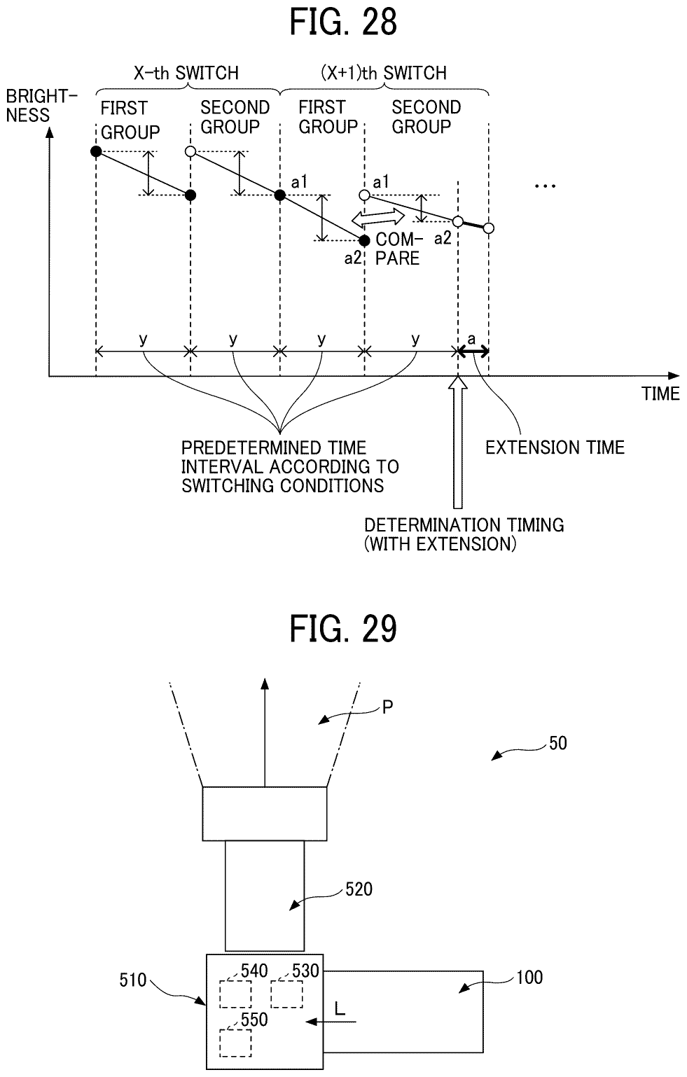

The light source device 100 can also change the predetermined time for switching based on the degree of deterioration of the group in use. A specific example is described with reference to FIGS. 27 and 28. FIG. 27 is a flowchart of the operation for changing the predetermined time for switching performed by the light source device 100. FIG. 28 is a diagram illustrating an example of an (X+1)^{-th} switching period. In FIG. 28, the X-axis represents time, and the Y-axis represents brightness.

In FIG. 27, first, in step S61, the light source device 100 acquires and stores brightness a1 using a color sensor at the start of turning on the first group G1.

Subsequently, in step S62, the light source device 100 determines whether a predetermined time has elapsed. When the light source device 100 determines that the predetermined time has not elapsed (NO in step S62), it repeats the process of step S62 until it determines that the predetermined time has elapsed. When the light source device 100 determines that the predetermined time has elapsed (YES in step S62), it acquires and stores current brightness a2 using the color sensor in step S63.

Subsequently, in step S64, the light source device 100 acquires and stores a changes in brightness between the brightness a1 and the brightness a2 for the first group G1.

Subsequently, in step S65, the light source device 100 switches the group of light sources, acquires and stores the brightness a1 of the second group G2.

Subsequently, in step S66, the light source device 100 determines whether a predetermined time has elapsed. When the light source device 100 determines that the predetermined time has not elapsed (NO in step S66), it repeats the process of step S66 until it determines that the predetermined time has elapsed. When the light source device 100 determines that the predetermined time has elapsed (YES in step S66), it acquires and stores current brightness a2 using the color sensor in step S67.

Subsequently, in step S68, the light source device 100 acquires and stores a changes in brightness between the brightness a1 and the brightness a2 for the second group G2.

Subsequently, in step S69, the light source device 100 compares the respective change amounts stored in the first group G1 and the second group G2.

Subsequently, in step S70, the light source device 100 determines whether the change amount of the first group G1 is smaller than the change amount of the second group G2. When the light source device 100 determines that the change amount of the first group G1 is smaller than the change amount of the second group G2 (YES in step S70), it further determines that the first group G1 deteriorates less than the second group G2, and switches the group from the second group G2 to the first group G1. In this case, the light source device 100 extends the next switching time by an additional a period (i.e., +a period of operation). Then, the light source device 100 ends the operation.

When the light source device 100 determines that the change amount of the first group G1 is not smaller than the change amount of the second group G2 (NO in step S70), it further determines that the second group G2 deteriorates less than the first group G1, and extends the operation time by an additional a period (i.e., +a period of operation) without immediately switching to the first group G1.

Subsequently, in step S66, the light source device 100 determines whether the extended time has been reached. When the light source device 100 determines that the extended time has not been reached (NO in step S73), it repeats the process of step S73 until it determines that the extended time has been reached. When the light source device 100 determines that the extended time has been reached (YES in step S73), it switches the group to the first group G1 in step S47. Then, the light source device 100 ends the operation. The extended time in step S73 is determined using Table 1 below, which associates the extended time with the amount of brightness change.

TABLE 1

| Amount of Change in Brightness | Extended Time |
|---|---|
| Up to x | +p hours |
| y to x | +q hours |
| etc. | etc. |

In the present example, the occurrence of illuminance unevenness after prolonged operation of the light source device 100 can be reduced, even if degradation progresses in one of the two sets.

### Seventh Example

Another configuration of the projection apparatus 50 is described below as a seventh example. FIG. 29 is a diagram illustrating another configuration of the projection apparatus 50.

The projection apparatus 50 illustrated in FIG. 29 includes an illumination optical system 510 and a projection unit 520, which are positioned downstream in the light-emission direction from the light source device 100 illustrated in FIG. 1. The light L from the light-transmitting element 3 of the light source device 100 enters the illumination optical system 510.

The illumination optical system 510 emits the light L to the projection unit 520. The illumination optical system 510 includes a color wheel 530, a light modulator 540, and an actuator 550.

The light modulator 540, when combined with the actuator 550, achieves a pseudo high resolution even if the physical resolution is full HD.

When the projection apparatus 50 detects, through the video signal detection unit 507, detects a high-resolution video signal, such as 4K, it projects the light L modulated by the light modulator 540 as a projection image P. In this case, the projection apparatus 50 drives the actuator 550 to shift the projection image P by half a pixel in both horizontal and vertical directions, cycling through four positions (e.g., upper left, upper right, lower right, and lower left from the center position) on the screen. To generate one frame of 4K video, four sub-frames are output from the light modulator 540.

Upon detecting a 3D video signal using the video signal detection unit 507, the projection apparatus 50 projects the light L modulated by the light modulator 540 as the projection image P. In this case, the projection apparatus subsequently projects the images for the right eye and the left eye as the projection image P onto the screen. To generate one frame of 3D video, two sub-frames are output from the light modulator 540. The user of the projection apparatus 50 can perceive the 3D image by viewing the screen through glasses that can control the filter for the right eye or the left eye in synchronization with the projection image P.

### Eighth Example

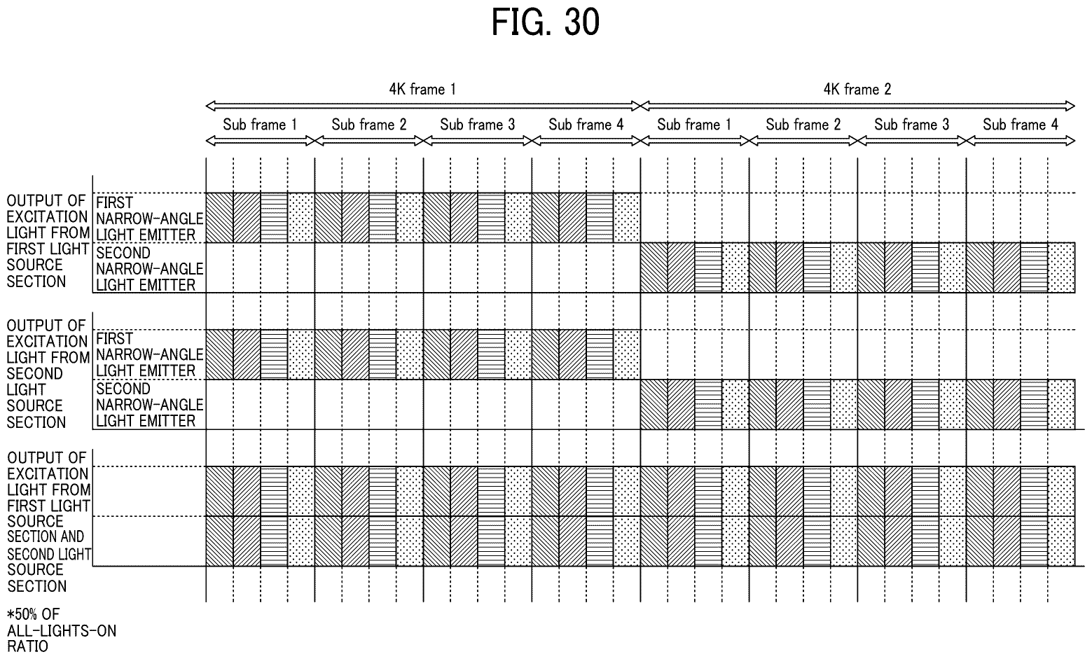

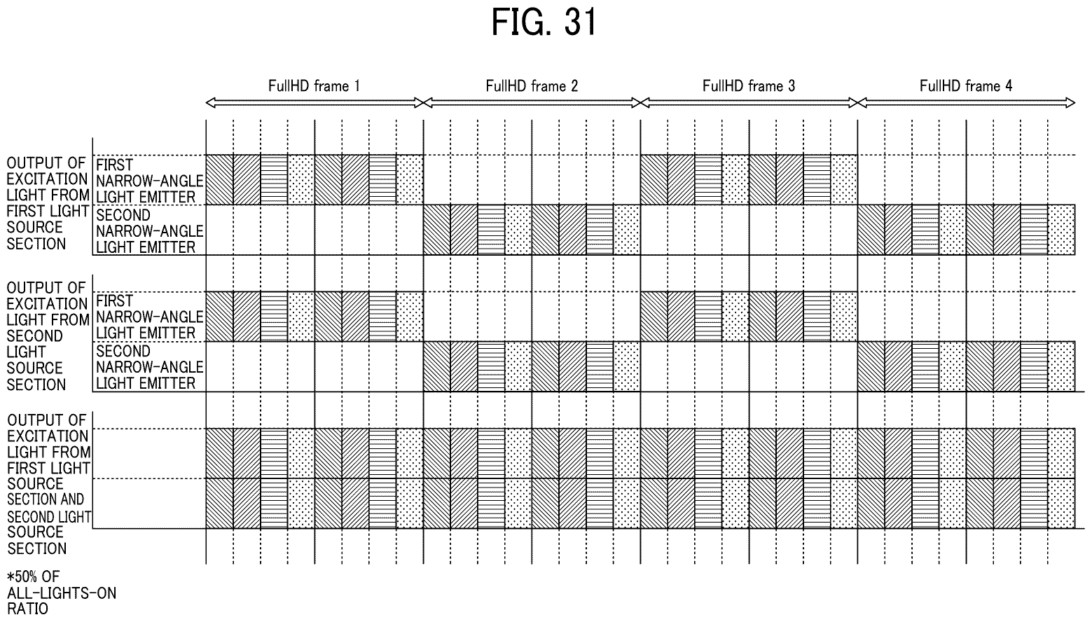

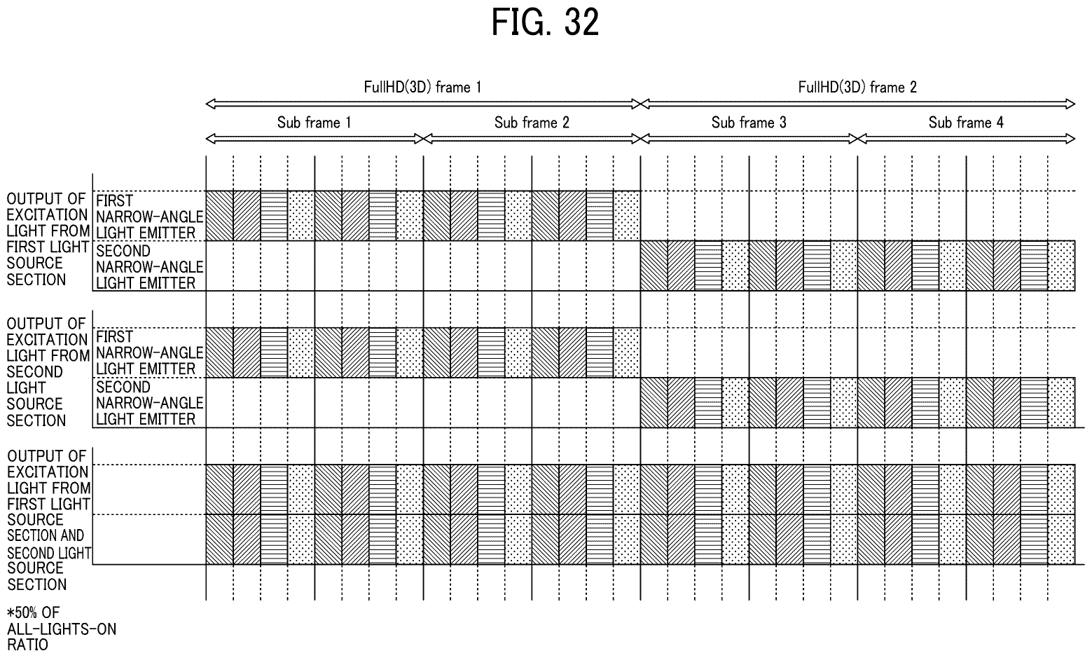

Various operation modes of the light source device 100 are described below according to an eighth example of the present disclosure. FIGS. 30 to 32 are diagrams each illustrating a different operation mode of the light source device 100. FIG. 30 is a diagram of a first example of the operation mode of the light source device 100. FIG. 31 is a diagram of a second example of the operation mode of the light source device 100. FIG. 32 is a diagram of a third example of the operation mode of the light source device 100. In FIGS. 30 to 32, a signal indicated by the right-downward diagonal hatching represents the emission timing of blue light from the light source device 100. The signal indicated by the upward-right diagonal hatching represents the emission timing of green light from the light source device 100. The signal indicated by the horizontal hatching represents the emission timing of yellow light from the light source device 100.

FIG. 30 presents the operation of the light source device 100 when the lighting pattern (i.e., pattern A and pattern B of the first pattern) in the double lifespan mode is switched for each frame of 4K among the four operation modes presented in FIG. 4.

FIG. 31 presents the operation of the light source device 100 when the video signal detection unit 507 receives, for example, a full high definition (HD) video signal, and the lighting pattern (i.e., pattern A and pattern B of the first pattern) in the double lifespan mode is switched for each frame of the full HD video signal among the four operation modes presented in FIG. 4.

FIG. 32 presents the operation of the light source device 100 when the video signal detection unit 507 receives, for example, a full HD (3D) video signal, and the lighting pattern (i.e., pattern A and pattern B of the first pattern) in the double lifespan mode is switched for each frame of the full HD (3D) video signal among the four operation modes presented in FIG. 4.

Although some embodiments have been described in detail, the present disclosure is not limited to the above-described embodiments, and various modifications and substitutions can be made to the above-described embodiments without departing from the scope of the claims.

All the numerals such as ordinal numbers and numbers used in the description of the embodiments are illustrative for specifically describing the technique of the present invention, and the present invention is not limited to the illustrated numerals. In addition, a connection relation between the components is an example for specifically describing the technology of the present disclosure, and a connection relation for implementing a function of the present disclosure is not limited thereto.

The division of blocks in the functional block diagram is an example, and multiple blocks may be implemented as one block, one block may be divided into multiple blocks, or some functions may be transferred to other blocks. Also, the functions of multiple blocks having similar functions may be processed in parallel or in a time-division manner by a single hardware or software. Alternatively, some or all of the functions may be distributed to multiple computers.

Aspects of the present disclosure are as follows, for example.

### Aspect 1

A light source device includes a first light source section including one or more first light emitters, each to emit first light; a second light source section including one or more second light emitters, each to emit second light; a light-transmissive member having a central axis to transmit the first light and the second light therethrough to allow the light source device to emit the first light and the second light transmitted through the light-transmissive member; and a drive section. The drive section individually reduces first amount of the first light emitted from each of the one or more first light emitters and second amount of the second light emitted from each of the one or more second light emitters; or individually turns off the one or more first light emitters and the one or more second light emitters. The first light enters the light-transmissive member at a positive angle relative to the central axis when the light-transmissive member is viewed in a direction orthogonal to the central axis of the light-transmissive member, and the second light enters the light-transmissive member at a negative angle relative to the central axis when viewed in the direction orthogonal to the central axis.

### Aspect 2

The light source device according to Aspect 1, further includes a controller including a light-emission control unit. The light-emission control unit individually reduce of first amount of the first light emitted from each of the one or more first light emitters and second amount of the second light emitted from each of the one or more second light emitters; or individually turn off the one or more first light emitters and the one or more second light emitters. The first light enters the light-transmissive member at a positive angle relative to the central axis in a plane orthogonal to the central axis (when the light-transmissive member is viewed in the direction orthogonal to the central axis of the light-transmissive member), and the second light enters the light-transmissive member at a negative angle relative to the central axis in the plane.

### Aspect 3

In the light source device according to Aspect 1 or 2, the first light source section includes two or more first light emitters including the one or more first light emitters, each of the two or more first light emitters including a first narrow-angle light emitter; and a first wide-angle light emitter. The second light source section includes two or more second light emitters including the one or more first light emitters, each of the two or more second light emitters including: a second narrow-angle light emitter; and a second wide-angle light emitter, in the plane orthogonal to the central axis (when the light-transmissive member is viewed in the direction orthogonal to the central axis of the light-transmissive member): a first absolute value of an angle of a principal ray of a first beam of the first light, emitted from the first narrow-angle light emitter to the light-transmissive member, relative to the central axis, is smaller than a second absolute value of an angle of a principal ray of a second beam of the first light, emitted from the first wide-angle light emitter to the light-transmissive member, relative to the central axis, and a third absolute value of an angle of a principal ray of a third beam of the second light, emitted from the second narrow-angle light emitter to the light-transmissive member, relative to the central axis, is smaller than a fourth absolute value of an angle of a principal ray of a fourth beam of the second light, emitted from the second wide-angle light emitter to the light-transmissive member, relative to the central axis.

### Aspect 4

In the light source device according to Aspect 3, in the plane orthogonal to the central axis (when the light-transmissive member is viewed in the direction orthogonal to the central axis of the light-transmissive member), the first absolute value is equal to the third absolute value, and the second absolute value is equal to the fourth absolute value.

### Aspect 5

In the light source device according to Aspect 3 or 4, the first narrow-angle light emitter and the second narrow-angle light emitter form a first group. The first wide-angle light emitter and the second wide-angle light emitter form a second group. The drive section further alternately turns off the first group and the second group; or alternately reduces the first amount of the first light emitted from the first group and the second amount of the second light emitted from the second group.

### Aspect 6

In the light source device according to Aspect 5, the drive section, according to a switching cycle, alternately turns off the first group and the second group; or alternately reduces the first amount of the first light emitted from the first group and the second amount of the second light emitted from the second group.

### Aspect 7

In the light source device according to any one of Aspects 1 to 6, each of the one or more first light emitters and the one or more second light emitters includes at least one of a light-emitting diode element or a semiconductor laser element.

### Aspect 8

The light source device according to any one of Aspects 1 to 7, further includes a rotatable wavelength converter including: a wavelength conversion area to receive the first light and the second light and emit wavelength-converted light; and a reflective area to receive the first light and the second light and emit reflected blue light. Each of the first light and the second light is blue, and the wavelength converter rotates to alternately emit the wavelength-converted light and the reflected blue light.

### Aspect 9

The light source device according to Aspect 8, each of the first light and the second light is light in a first wavelength range. The wavelength converter receives the first light and the second light and emits light in a second wavelength range different from the first wavelength range. The light source device emits: the light in the first wavelength range that has not passed through the wavelength converter during a first period (t1); the light in the second wavelength range emitted from the wavelength converter during a second period (t2) different from the first period (t1). The light source device has: a first mode to emit light at a first output level by covering at least part of each of the light in the first wavelength range emitted during the first period (t1) and the light in the second wavelength range emitted during the second period (t2); or by combining at least part of the first period (t1) with at least part of the second period (t2); and a second mode to emit light at a second output level different from the first output level. A first ratio (η1) of M1_PLD1 to M1_PLD2 is different from a second ratio (η2) of M2_PLD1 to M2_PLD2, where M1_PLD1 indicates an output of the first light source section to allow the light source device to emit the light in the first wavelength range in the first mode, M1_PLD2 indicates an output of the one or more first light emitters or the one or more second light emitters to allow the light source device to emit the light in the second wavelength range in the first mode, M2_PLD1 indicates an output of the one or more first light emitters or the one or more second light emitters to allow the light source device to emit the light in the first wavelength range in the second mode, and M2_PLD2 indicates an output of the one or more first light emitters or the one or more second light emitters to allow the light source device to emit the light in the second wavelength range in the second mode.

### Aspect 10

In the light source device according to Aspect 9, a ratio of an output of the light in the second wavelength range received and emitted from the wavelength converter to an output of the light in the first wavelength range incident on the wavelength converter decreases as the output of the light in the first wavelength range increases.

### Aspect 11

In the light source device according to Aspect 9 or 10, an amount of light emitted from the light source device in the first mode is greater than an amount of light emitted from the light source device in the second mode, and the first ratio (1η) is smaller than the second ratio (η2) (1η<η2).

### Aspect 12

In the light source device according to any one of Aspects 9 to 11, light source device emits: light with first chromaticity coordinates in the first mode; and light with second chromaticity coordinates in the second mode. The second ratio (η2) is set so that the first chromaticity coordinates approximately match the second chromaticity coordinates.

### Aspect 13

In the light source device according to any one of Aspects 9 to 12, the wavelength converter receives the light in the second wavelength range and emits light in a third wavelength range, and the light source device emits at least the light in the first wavelength range and the light in the third wavelength range.

### Aspect 14

The light source device according to any one of Aspects 1 to 13, further includes: a rotatable first wavelength converter including: a first wavelength conversion area to receive the first light and emit wavelength-converted light; and a first reflective area to receive the first light and emit reflected blue light; and a rotatable second wavelength converter including: a second wavelength conversion area to receive the second light and emit the wavelength-converted light; and a second reflective area to receive the second light and emit the reflected blue light. Each of the first light and the second light is blue, and each of the first wavelength converter and the second wavelength converter rotates to allow the light-transmissive member to alternately emit the wavelength-converted light and the reflected blue light.

### Aspect 15

In the light source device according to any one of Aspects 1 to 14, the drive section further alternately turns on the first light source section and the second light source section.

### Aspect 16

In the light source device according to any one of Aspects 1 to 14, the drive section further simultaneously turns on the first light source section and the second light source section.

### Aspect 17

A light source device includes: a first light source section including one or more first light emitters, each to emit first light; a second light source section including one or more second light emitters, each to emit second light; a light-transmissive member having a central axis to transmit the first light and the second light therethrough to allow the light source device to emit the first light and the second light transmitted through the light-transmissive member; a drive section to individually drive each of the one or more first light emitters and the one or more second light emitters; and a controller configured to control an operation of the drive section. The controller causes the drive section to: individually reduce first amount of the first light emitted from each of the one or more first light emitters and second amount of the second light emitted from each of the one or more second light emitters; or individually turn off the one or more first light emitters and the one or more second light emitters; and alternately switch between: a first state where both the first light and the second light enter the light-transmissive member at a positive angle relative to the central axis of the light-transmissive member; and a second state where both the first light and the second light enter the light-transmissive member at a negative angle relative to the central axis of the light-transmissive member, at a switching cycle when the light-transmissive member is viewed in the direction orthogonal to the central axis of the light-transmissive member.

### Aspect 18

A projection apparatus incudes: the light source device according to any one of Aspects 1 to 17; a light modulator to spatially modulate light emitted from the light-transmissive member; and a projector to project the light modulated by the light modulator.

### Aspect 19

A projection apparatus includes: the light source device according to any one of Aspects 6 to 17; a light modulator to spatially modulate light emitted from the light source device; and a projector to project the light modulated by the light modulator. The light modulator further generates a projection image with the light at a frame cycle, and a length of the switching cycle is less than or equal to a length of the frame cycle.

### Aspect 20

A projection apparatus includes: the light source device according to Aspect 5; a light modulator to spatially modulate light emitted from the light source device; and a projector to project the light modulated by the light modulator. At each startup of the projection apparatus, the drive section: alternately turns off the first group and the second group; or alternately reduces the first amount of the first light emitted from the first group and the second amount of the second light emitted from the second group.

### Aspect 21

A light source device includes a first light source section including one or more first light emitters to emit first light; a second light source section including one or more second light emitters to emit second light; a light-transmissive member having a central axis to transmit the first light and the second light therethrough to emit the first light and the second light from the light-transmissive member; and circuitry configured to individually drive the one or more first light emitters and the one or more second light emitters to reduce illuminance of light emitted from the light-transmissive member to be below a predetermined illuminance level. The first light source section emits the first light that enters the light-transmissive member at a positive angle relative to the central axis in a view in a direction orthogonal to the central axis. The second light source section emits the second light that enters the light-transmissive member at a negative angle relative to the central axis in the view in a direction orthogonal to the central axis.

### Aspect 22

In the light source device according to Aspect 21, the circuitry is further configured to: cause the one or more first light emitters to individually reduce first amount of the first light and cause the one or more second light emitters to individually reduce second amount of the second light; or individually turn off the one or more first light emitters and the one or more second light emitters.

### Aspect 23

In the light source device according to Aspect 21, the one or more first light emitters include a first narrow-angle light emitter; and a first wide-angle light emitter. The one or more second light emitters include a second narrow-angle light emitter; and a second wide-angle light emitter, and the first narrow-angle light emitter emits a first beam of the first light to the light-transmissive member. The first wide-angle light emitter emits a second beam of the first light to the light-transmissive member. The second narrow-angle light emitter emits a third beam of the second light to the light-transmissive member. The second wide-angle light emitter emits a fourth beam of the second light to the light-transmissive member. A first absolute value of an angle of a principal ray of the first beam of the first light is smaller than a second absolute value of an angle of a principal ray of the second beam of the first light, relative to the central axis. A third absolute value of an angle of a principal ray of the third beam of the second light is smaller than a fourth absolute value of an angle of a principal ray of the fourth beam of the second light, relative to the central axis.

### Aspect 24

In the light source device according to Aspect 21, the first light source section further includes a first start point (L1S) to emit the first light toward the light-transmissive member, the second light source section further includes a second start point (L2S) to emit the second light toward the light-transmissive member. The light-transmissive member further includes a first end point (L1E) to receive the first light from the first start point and a second end point (L2E) to receive the second light from the second start point. The first start point is connected to the first end point by a first line segment. The second start point is connected to the second end point by a second line segment. The direction orthogonal to the central axis divides an angle, between a first line orthogonal to the first line segment and a second line orthogonal to the second line segment, into symmetrical angles. Each of the one or more first light emitters and the one or more second light emitters includes at least one of a light-emitting diode element or a semiconductor laser element.

### Aspect 25

A light source device includes a first light source section including one or more first light emitters to emit first light; a second light source section including one or more second light emitters to emit second light; a light-transmissive member having a central axis to transmit the first light and the second light therethrough to emit the first light and the second light from the light-transmissive member; and circuitry to cause the one or more first light emitters to individually reduce first amount of the first light and cause the one or more second light emitters to individually reduce second amount of the second light; or individually turn off the one or more first light emitters and the one or more second light emitters. The circuitry is alternately switchable, at a switching cycle, between: a first state where both the first light and the second light enter the light-transmissive member at a positive angle relative to the central axis of the light-transmissive member in a view in a direction orthogonal to the central axis of the light-transmissive member; and a second state where both the first light and the second light enter the light-transmissive member at a negative angle relative to the central axis of the light-transmissive member in the view in the direction orthogonal to the central axis of the light-transmissive member.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A light source device comprising:
a first light source section including one or more first light emitters to emit first light;
a second light source section including one or more second light emitters to emit second light;
a light-transmissive member having a central axis to transmit the first light and the second light therethrough to emit the first light and the second light from the light-transmissive member; and
circuitry configured to individually drive the one or more first light emitters and the one or more second light emitters to reduce illuminance of light emitted from the light-transmissive member to be below a predetermined illuminance level,
wherein the first light source section emits the first light that enters the light-transmissive member at a positive angle relative to the central axis in a view in a direction orthogonal to the central axis, and
the second light source section emits the second light that enters the light-transmissive member at a negative angle relative to the central axis in the view in the direction orthogonal to the central axis.

2. The light source device according to claim 1,
wherein the circuitry is further configured to:
cause the one or more first light emitters to individually reduce first amount of the first light and cause the one or more second light emitters to individually reduce second amount of the second light; or
individually turn off the one or more first light emitters and the one or more second light emitters.

3. The light source device according to claim 1,
wherein the one or more first light emitters including:
a first narrow-angle light emitter; and
a first wide-angle light emitter,
the one or more second light emitters including:
a second narrow-angle light emitter; and
a second wide-angle light emitter, and
the first narrow-angle light emitter emits a first beam of the first light to the light-transmissive member,
the first wide-angle light emitter emits a second beam of the first light to the light-transmissive member,
the second narrow-angle light emitter emits a third beam of the second light to the light-transmissive member,
the second wide-angle light emitter emits a fourth beam of the second light to the light-transmissive member, and
a first absolute value of an angle of a principal ray of the first beam of the first light is smaller than a second absolute value of an angle of a principal ray of the second beam of the first light, relative to the central axis,
a third absolute value of an angle of a principal ray of the third beam of the second light is smaller than a fourth absolute value of an angle of a principal ray of the fourth beam of the second light, relative to the central axis.

4. The light source device according to claim 3,
wherein in the plane orthogonal to the central axis,
the first absolute value is equal to the third absolute value, and
the second absolute value is equal to the fourth absolute value.

5. The light source device according to claim 3,
wherein the first narrow-angle light emitter and the second narrow-angle light emitter form a first group,
the first wide-angle light emitter and the second wide-angle light emitter form a second group, and
the circuitry further:
alternately turns off the first group and the second group; or
alternately reduces the first amount of the first light emitted from the first group and the second amount of the second light emitted from the second group.

6. The light source device according to claim 5,
wherein the circuitry, according to a switching cycle:
alternately turns off the first group and the second group; or
alternately reduces the first amount of the first light emitted from the first group and the second amount of the second light emitted from the second group.

7. The light source device according to claim 1, wherein:
the first light source section further includes a first start point to emit the first light toward the light-transmissive member,
the second light source section further includes a second start point to emit the second light toward the light-transmissive member,
the light-transmissive member further includes a first end point to receive the first light from the first start point and a second end point to receive the second light from the second start point,
the first start point is connected to the first end point by a first line segment,
the second start point is connected to the second end point by a second line segment,
the direction orthogonal to the central axis divides an angle, between a first line orthogonal to the first line segment and a second line orthogonal to the second line segment, into symmetrical angles, and
each of the one or more first light emitters and the one or more second light emitters includes at least one of a light-emitting diode element or a semiconductor laser element.

8. The light source device according to claim 1, further comprising a rotatable wavelength converter including:
a wavelength conversion area to receive the first light and the second light and emit wavelength-converted light; and
a reflective area to receive the first light and the second light and emit reflected blue light,
wherein each of the first light and the second light is blue light, and
the wavelength converter rotates to alternately emit the wavelength-converted light and the reflected blue light.

9. The light source device according to claim 8,
wherein each of the first light and the second light is light in a first wavelength range,
the wavelength converter receives the first light and the second light and emits light in a second wavelength range different from the first wavelength range,
the light source device emits:
the light in the first wavelength range that has not passed through the wavelength converter during a first period (t1);
the light in the second wavelength range emitted from the wavelength converter during a second period (t2) different from the first period (t1); and
the light source device has:
a first mode to emit light at a first output level:
by covering at least part of each of the light in the first wavelength range emitted during the first period (t1) and the light in the second wavelength range emitted during the second period (t2); or
by combining at least part of the first period (t1) with at least part of the second period (t2); and
a second mode to emit light at a second output level different from the first output level, and
a first ratio (η1) of M1_PLD1 to M1_PLD2 is different from a second ratio (η2) of M2_PLD1 to M2_PLD2,
where
M1_PLD1 indicates an output of the first light source section to allow the light source device to emit the light in the first wavelength range in the first mode,
M1_PLD2 indicates an output of the one or more first light emitters or the one or more second light emitters to allow the light source device to emit the light in the second wavelength range in the first mode,
M2_PLD1 indicates an output of the one or more first light emitters or the one or more second light emitters to allow the light source device to emit the light in the first wavelength range in the second mode, and
M2_PLD2 indicates an output of the one or more first light emitters or the one or more second light emitters to allow the light source device to emit the light in the second wavelength range in the second mode.

10. The light source device according to claim 9,
wherein a ratio of an output of the light in the second wavelength range received and emitted from the wavelength converter to an output of the light in the first wavelength range incident on the wavelength converter decreases as the output of the light in the first wavelength range increases.

11. The light source device according to claim 9,
wherein an amount of light emitted from the light source device in the first mode is greater than an amount of light emitted from the light source device in the second mode, and
the first ratio (1η) is smaller than the second ratio (η2) (1η<η2).

12. The light source device according to claim 9,
wherein light source device emits:
light with first chromaticity coordinates in the first mode; and
light with second chromaticity coordinates in the second mode, and
the second ratio (η2) is set so that the first chromaticity coordinates approximately match the second chromaticity coordinates.

13. The light source device according to claim 9,
wherein the wavelength converter receives the light in the second wavelength range and emits light in a third wavelength range, and
the light source device emits at least the light in the first wavelength range and the light in the third wavelength range.

14. The light source device according to claim 1, further comprising:
a rotatable first wavelength converter including:
a first wavelength conversion area to receive the first light and emit wavelength-converted light; and
a first reflective area to receive the first light and emit reflected blue light; and
a rotatable second wavelength converter including:
a second wavelength conversion area to receive the second light and emit the wavelength-converted light; and
a second reflective area to receive the second light and emit the reflected blue light,
wherein each of the first light and the second light is blue light, and
each of the first wavelength converter and the second wavelength converter rotates to allow the light-transmissive member to alternately emit the wavelength-converted light and the reflected blue light.

15. The light source device according to claim 1,
wherein the circuitry further alternately turns on the first light source section and the second light source section.

16. The light source device according to claim 1,
wherein the circuitry further simultaneously turns on the first light source section and the second light source section.

17. Alight source device comprising:
a first light source section including one or more first light emitters to emit first light;
a second light source section including one or more second light emitters to emit second light;
a light-transmissive member having a central axis to transmit the first light and the second light therethrough to emit the first light and the second light from the light-transmissive member; and
circuitry configured to:
cause the one or more first light emitters to individually reduce first amount of the first light and cause the one or more second light emitters to individually reduce second amount of the second light; or
individually turn off the one or more first light emitters and the one or more second light emitters; and
alternately switchable, at a switching cycle, between:
a first state where both the first light and the second light enter the light-transmissive member at a positive angle relative to the central axis of the light-transmissive member in a view in a direction orthogonal to the central axis of the light-transmissive member; and
a second state where both the first light and the second light enter the light-transmissive member at a negative angle relative to the central axis of the light-transmissive member in the view in the direction orthogonal to the central axis.

18. A projection apparatus comprising:
the light source device according to claim 1;
a light modulator to spatially modulate light emitted from the light-transmissive member; and
a projector to project the light modulated by the light modulator.

19. A projection apparatus comprising:
the light source device according to claim 6;
a light modulator to spatially modulate light emitted from the light source device; and
a projector to project the light modulated by the light modulator,
wherein the light modulator further generates a projection image with the light at a frame cycle, and
a length of the switching cycle is less than or equal to a length of the frame cycle.

20. A projection apparatus comprising:
the light source device according to claim 5;
a light modulator to spatially modulate light emitted from the light source device; and
a projector to project the light modulated by the light modulator,
wherein at each startup of the projection apparatus, the drive section:
alternately turns off the first group and the second group; or
alternately reduces the first amount of the first light emitted from the first group and the second amount of the second light emitted from the second group.
